(19) United States
(12) Patent Application Publication
(10) Pub. No.: US 2015/0010057 A1
(43) Pub. Date: Jan. 8, 2015

(54) IMAGE DECODING DEVICE AND IMAGE DECODING METHOD

(71) Applicant: Panasonic Corporation, Osaka (JP)

(72) Inventors: Hiroshi Amano, Osaka (JP); Takeshi Tanaka, Osaka (JP); Kenji Oga, Osaka (JP)

(21) Appl. No.: 14/384,545

(22) PCT Filed: Feb. 21, 2013
(86) PCT No.: PCT/JP2013/000998

§ 371 Date: Sep. 11, 2014

(30) Foreign Application Priority Data
Mar. 16, 2012 (JP) 2012-060621

(51) Int. Cl. H04N 19/65; H04N 19/89; H04N 19/196; H04N 19/11; H04N 19/136; H04N 19/44; H04N 19/51

(52) U.S. Cl. CPC H04N 19/00854; H04N 19/00533; H04N 19/00933; H04N 19/00703; H04N 19/00042; H04N 19/00139; H04N 19/00369; H04N 19/00939
USPC 375/240.02; 375/240.25; 375/240.16

(57) ABSTRACT

An image decoding device which decodes an encoded stream of images each divided into plural units. The image decoding device including: a parameter candidate generating unit configured to generate a parameter candidate list including one or more parameter candidates each of which is available to decode a decoding target unit, using one or more parameters used in decoding of one or more decoded units; a parameter information decoder which decodes parameter information included in the encoded stream and related to the one or more parameter candidates; and an error detecting unit configured to detect, as an error, a state in which the parameter information decoded by the parameter information decoder does not have a match in the parameter candidate list generated by the parameter candidate generating unit.

### TECHNICAL FIELD

The present invention relates to an image decoding device which decodes an encoded stream of images each divided into a plurality of units.

### BACKGROUND ART

Techniques related to image decoding devices which decode encoded streams of images include techniques disclosed in Patent Literature 1, Non Patent Literature 1, and Non Patent Literature 2.

### CITATION LIST

### Patent Literature

### [PTL 1]

Japanese Patent Publication No. 3322670

### Non Patent Literature

### [NPL 1]

ITU-T Recommendation H.264 “Advanced video coding for generic audiovisual services”, March, 2010

### [NPL 2]

“Working Draft 5 of High-Efficiency Video Coding”, [online], Joint Collaborative Team on video coding (JCT-VC), Jan. 20, 2012, [searched on Jan. 20, 2012], Internet <URL: http: phenix.int-evry.fr/jct/doc_end_user/documents/7_Geneva/wg11/JC TVC-G1103-v9.zip>

### SUMMARY OF INVENTION

### Technical Problem

However, there is a possibility that an encoded stream of images includes an error that is not assumed in the prior art.

In view of this, the present invention provides an image decoding device which decodes an encoded stream of images with a high error resilience.

### Solution to Problem

An image decoding device according to an aspect of the present invention is an image decoding device which decodes an encoded stream of images each divided into a plurality of units, the image decoding device including: a parameter candidate generating unit configured to generate a parameter candidate list including one or more parameter candidates each of which is available to decode a decoding target unit, using one or more parameters used in decoding of one or more decoded units; a parameter information decoder which decodes parameter information included in the encoded stream and related to the one or more parameter candidates; and an error detecting unit configured to detect, as an error, a state in which the parameter information decoded by the parameter information decoder does not have a match in the parameter candidate list generated by the parameter candidate generating unit.

These general and specific aspects may be implemented using a system, a method, an integrated circuit, a computer program, or a non-transitory computer-readable recording medium such as a CD-ROM, or any combination of systems, methods, integrated circuits, computer programs, or recording media.

### Advantageous Effects of Invention

The image decoding device according to an aspect of the present invention is an image decoding device which decodes an encoded stream of images with a high error resilience.

### BRIEF DESCRIPTION OF DRAWINGS

FIG. 1A is a diagram illustrating an example of a codeword table of a conventional codec.

FIG. 1B is a diagram illustrating an example of a codeword table of a codec in recent years.

FIG. 2 is a block diagram illustrating a structure of an image decoding device according to Embodiment 1.

FIG. 3 is a block diagram illustrating structures of a motion vector calculating unit and a motion vector compensating unit according to Embodiment 1.

FIG. 4A is a diagram illustrating an example of a sequence according to Embodiment 1.

FIG. 4B is a diagram illustrating examples of pictures according to Embodiment 1.

FIG. 4C is a diagram illustrating an example of an encoded stream according to Embodiment 1.

FIG. 5A is a diagram illustrating an example of a coding unit according to Embodiment 1.

FIG. 5B is a diagram illustrating an example of data of a coding unit layer according to Embodiment 1.

FIG. 6A is a diagram illustrating an example of data of a coding unit according to Embodiment 1.

FIG. 6B is a diagram illustrating examples of prediction unit sizes according to Embodiment 1.

FIG. 6C is a diagram illustrating examples of transform unit sizes according to Embodiment 1.

FIG. 7 is a flowchart of decoding a sequence according to Embodiment 1.

FIG. 8 is a flowchart of decoding a coding unit according to Embodiment 1.

FIG. 9 is a flowchart of an error detection according to Embodiment 1.

FIG. 10 is a flowchart of operations for calculating motion vector predictor candidates from spatially neighboring prediction units according to Embodiment 1.

FIG. 11 is a diagram illustrating examples of spatially neighboring prediction units according to Embodiment 1.

FIG. 12 is a diagram illustrating a first example of a determination on availability of each of the spatially neighboring prediction units according to Embodiment 1.

FIG. 13A is a diagram illustrating a second example of a determination on availability of each of spatially neighboring prediction units according to Embodiment 1.

FIG. 13B is a diagram illustrating a third example of a determination on availability of each of spatially neighboring prediction units according to Embodiment 1.

FIG. 14 is a flowchart of operations for calculating motion vector predictor candidates from temporally neighboring prediction units according to Embodiment 1.

FIG. 15 is a diagram illustrating examples of temporally neighboring prediction units according to Embodiment 1.

FIG. 16 is a diagram illustrating examples of operations for calculating motion vector predictor candidates from temporally neighboring prediction units according to Embodiment 1.

FIG. 17A is a diagram illustrating a first state of a motion vector predictor candidate list according to Embodiment 1.

FIG. 17B is a diagram illustrating a second state of a motion vector predictor candidate list according to Embodiment 1.

FIG. 18 is a diagram illustrating examples of error detections according to Embodiment 1.

FIG. 19 is a flowchart of an error concealment according to Embodiment 2.

FIG. 20 is a block diagram of a structure of an integrated circuit according to Embodiment 3.

FIG. 21 is a block diagram illustrating a structure of an image decoding device according to Embodiment 4.

FIG. 22 is a flowchart of operations by an image decoding device according to Embodiment 4.

FIG. 23 is a block diagram illustrating a structure of an image decoding device according to Variation 1 of Embodiment 4.

FIG. 24 is a flowchart of operations by the image decoding device according to Variation 1 of Embodiment 4.

FIG. 25 is a block diagram illustrating a structure of an image decoding device according to Variation 2 of Embodiment 4.

FIG. 26 is a flowchart of operations by the image decoding device according to Variation 2 of Embodiment 4.

FIG. 27 shows an overall configuration of a content providing system for implementing content distribution services.

FIG. 28 shows an overall configuration of a digital broadcasting system.

FIG. 29 shows a block diagram illustrating an example of a configuration of a television.

FIG. 30 shows a block diagram illustrating an example of a configuration of an information reproducing/recording unit that reads and writes information from and on a recording medium that is an optical disk.

FIG. 31 shows an example of a configuration of a recording medium that is an optical disk.

FIG. 32A shows an example of a cellular phone.

FIG. 32B is a block diagram showing an example of a configuration of a cellular phone.

FIG. 33 illustrates a structure of multiplexed data.

FIG. 34 schematically shows how each stream is multiplexed in multiplexed data.

FIG. 35 shows how a video stream is stored in a stream of PES packets in more detail.

FIG. 36 shows a structure of TS packets and source packets in the multiplexed data.

FIG. 37 shows a data structure of a PMT.

FIG. 38 shows an internal structure of multiplexed data information.

FIG. 39 shows an internal structure of stream attribute information.

FIG. 40 shows steps for identifying Video data.

FIG. 41 shows an example of a configuration of an integrated circuit for implementing the moving picture coding method according to each of embodiments.

FIG. 42 shows a configuration for switching between driving frequencies.

FIG. 43 shows steps for identifying video data and switching between driving frequencies.

FIG. 44 shows an example of a look-up table in which video data standards are associated with driving frequencies.

FIG. 45A is a diagram showing an example of a configuration for sharing a module of a signal processing unit.

FIG. 45B is a diagram showing another example of a configuration for sharing a module of the signal processing unit.

### DESCRIPTION OF EMBODIMENTS

(Underlying Knowledge Forming Basis of the Present Disclosure)

The Inventors found problems related to image decoding devices. Hereinafter, these problems related to the image decoding devices are described in detail.

The image encoding device which encodes images divides each of pictures included in an image into a plurality of macroblocks (which are also referred to as an abbreviation of MB) each composed of 16×16 pixels. The image encoding device then encodes the respective macroblocks in a raster scan order. The image encoding device generates an encoded stream by encoding and compressing images. An image decoding device decodes the encoded stream on a per macroblock basis in the raster scan order to reproduce each of the pictures in the original image.

One of the conventional image encoding methods is H.264 standard by the ITU-T (for example, see Non Patent Literature 1). The image decoding device firstly reads an encoded stream in order to decode images encoded using the H.264 standard. The image decoding device next decodes various kinds of header information, and then performs variable length decoding. The image decoding device performs inverse quantization on coefficient information obtained through variable length decoding, and performs inverse frequency transform. In this way, a difference image is generated.

Next, the image decoding device performs intra prediction or motion compensation, according to the type of a macroblock obtained through the variable length decoding. Here, the motion compensation is performed on a macroblock composed of 16×16 pixels at the maximum. In this way, the image decoding device generates a prediction image. Consequently, the image decoding device performs a reconstruction process by adding the prediction image and the difference image. Next, the image decoding device decodes a decoding target image by performing in-loop filter process on the reconstructed image.

As described above, the image encoding device according to the H.264 standard encodes an image in units of a macroblock composed of 16×16 pixels. However, the 16×16 pixels are not always optimum as a coding unit. In general, as the resolution of an image becomes higher, a correlation between neighboring blocks becomes higher. For this reason, it is possible to further increase a compression efficiency when a coding unit is made larger.

In recent years, high-definition displays such as 4k2k (3840 pixels=160 pixels) etc. have been developed. Accordingly, it is predicted that image resolutions to be handled become increasingly higher. As the image resolutions become increasingly higher, it becomes more difficult for image encoding devices according to the H.264 standard to encode high-resolution images efficiently.

On the other hand, techniques proposed as the next-generation image encoding standards include a technique for solving such a problem (Non Patent Literature 2). In this technique, a coding unit block having a variable size corresponds to a macroblock in the conventional H.264. In this way, the image encoding device according to the technique is capable of encoding an image in units of a block larger than the conventional 16×16 pixels, and is also capable of encoding a high-definition image appropriately.

More specifically, in Non Patent Literature 2, a coding unit (CU) is defined as a data unit in encoding. This coding unit is a data unit based on which intra prediction for performing intra-frame prediction and an inter prediction for performing motion compensation can be switched, as in the case of a macroblock in the conventional encoding standard. The coding unit is defined as the most basic block in encoding.

The size of this coding unit is either 8×8 pixels, 16×16 pixels, 32×32 pixels, or 64×64 pixels. The coding unit that is the largest one is called a largest coding unit (LCU). Furthermore, a transform unit (TU) is defined as a frequency transform size. The transform unit is also called as a frequency transform unit.

As transform units, various rectangular sizes of 4×4 pixels or larger are used. Examples include 4×4 pixels, 8×8 pixels, 16×16 pixels, 16×12 pixels, 32×32 pixels, etc.

In addition, a prediction unit (PU) included in a coding unit is defined as a unit in intra prediction or inter prediction. As prediction units, various rectangular sizes of 4×4 pixels or larger are used. Examples include 64×64 pixels, 64×32 pixels, 32×64 pixels, 32×32 pixels, 32×26 pixels, 16×32 pixels, 16×12 pixels etc.

In addition, with the spread of the Internet, videos are handled through networks in which communication qualities are not always stable in many cases. For this reason, it is expected that an error resilience is increased by increasing accuracies in error detection and error processing. With regard to this, for example, a technique for determining that an error is included when a motion vector indicates outside of a picture (see Patent Literature 1).

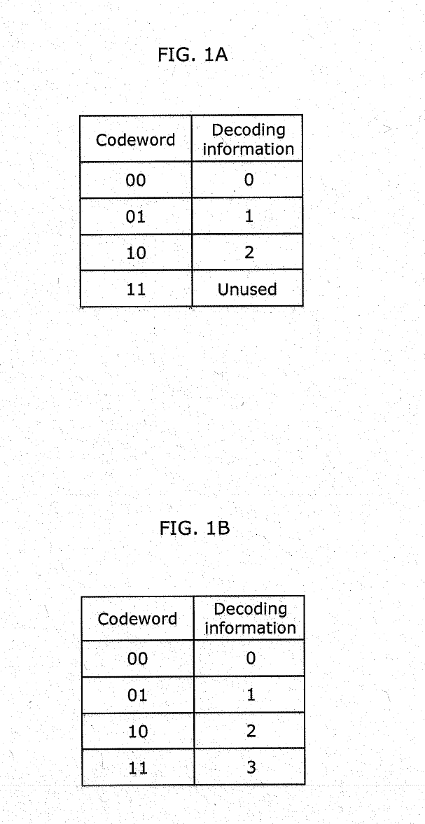

In addition, in recent years, it is difficult to detect an error from a bitstream because redundancy in variable length encoding is low. For example, a conventional codeword table includes redundancy because it includes an unused codeword “11” as illustrated in FIG. 1A. However, in a recent codeword table, as illustrated in FIG. 1B, decoding information “3” is assigned instead of the unused codeword “11” assigned conventionally. In this way, redundancy is decreased in recent years.

For this reason, for example, even when an error that is a bit loss or the like occurs, there is a possibility that the error is not detected from the bitstream and unconceivable information is decoded. In addition, the decoded unconceivable information may exert a harmful effect of, for example, stopping decoding the encoded stream.

In addition, the technique disclosed in Non Patent Literature 2 identifies a prediction parameter of a decoding target prediction unit, from a plurality of prediction parameters used in the decoding of a plurality of decoded prediction units. The image decoding device then decodes the decoding target prediction unit using the identified prediction parameter.

More specifically, the image decoding device generates a prediction parameter candidate list including a plurality of prediction parameter candidates, using the plurality of prediction parameters of the plurality of decoded prediction units. The image decoding device then identifies a prediction parameter from the prediction parameter candidate list, using prediction parameter identification information separately encoded in the encoded stream. The image decoding device then decodes the decoding target prediction unit using the identified prediction parameter. Here, the prediction parameter is, for example, a motion vector or an intra prediction mode.

The technique is made based on the premise that prediction parameter identification information is correct, and without considering that the prediction parameter candidate list does not include any prediction parameter identified by the prediction parameter identification information. For this reason, for example, even when the prediction parameter identification information is incorrect, the image decoding device according to the technique cannot detect an error in the prediction parameter identification information.

In addition, there is a possibility that the same prediction parameter candidate list as the prediction parameter candidate list used in encoding is not generated, for example, due to a bit loss at the time of transmission, a data replacement in other error processing. The image decoding device according to the above-described technique cannot detect, as an error, the inappropriate prediction parameter candidate list.

In view of this, an image decoding device according to an aspect of the present invention is an image decoding device which decodes an encoded stream of images each divided into a plurality of units, the image decoding device including: a parameter candidate generating unit configured to generate a parameter candidate list including one or more parameter candidates each of which is available to decode a decoding target unit, using one or more parameters used in decoding of one or more decoded units; a parameter information decoder which decodes parameter information included in the encoded stream and related to the one or more parameter candidates; and an error detecting unit configured to detect, as an error, a state in which the parameter information decoded by the parameter information decoder does not have a match in the parameter candidate list generated by the parameter candidate generating unit.

In this way, the image decoding device is capable of detecting, as the error, the mismatch between the parameter candidate list and the parameter information. Accordingly, the error resilience is increased.

For example, the parameter information decoder may decode the parameter information which is information for identifying a parameter to be used to decode the decoding target unit from the parameter candidate list, and the error detecting unit may be configured to detect, as the error, the state which is a state in which the parameter identified by the parameter information decoded by the parameter information decoder is absent in the parameter candidate list.

In this way, the image decoding device is capable of detecting, as the error, the state in which the parameter candidate list does not include the parameter identified by the parameter information. Accordingly, the error resilience is increased.

In addition, for example, the parameter information decoder may decode the parameter information which indicates a largest number for the one or more parameter candidates, and the error detecting unit may be configured to detect, as the error, the state which is a state in which the number of the one or more parameter candidates included in the parameter candidate list generated by the parameter candidate generating unit is larger than the largest number indicated by the parameter information decoded by the parameter information decoder.

In this way, the image decoding device is capable of detecting, as the error, the state in which the number of candidates is too large. Accordingly, the error resilience is increased.

In addition, for example, the parameter information decoder may decode the parameter information which is information indicating an identification number of a parameter to be used to decode the decoding target unit from the parameter candidate list, and the error detecting unit may be configured to detect, as the error, the state which is a state in which the identification number indicated by the parameter information decoded by the parameter information decoder is larger than the largest number for the one or more parameter candidates included in the parameter candidate list.

In this way, the image decoding device is capable of detecting, as the error, the state in which the identification numbers of candidates are larger than the number of candidates. Accordingly, the error resilience is increased.

In addition, for example, each of the plurality of units may be a prediction unit.

In this way, the error in the parameter corresponding to the prediction unit is detected appropriately. Accordingly, the error resilience related to the prediction is increased.

In addition, for example, each of the one or more parameter candidates included in the parameter candidate list may be a motion vector predictor candidate.

In this way, the error related to the motion vector predictor is detected appropriately. Accordingly, the error resilience related to the inter prediction is increased.

In addition, for example, each of the one or more parameter candidates included in the parameter candidate list may be an intra prediction mode candidate.

In this way, the error related to the intra prediction mode is detected appropriately. Accordingly, the error resilience related to the intra prediction is increased.

In addition, for example, the image decoding device may further include an image decoder which identifies a parameter to be used to decode the decoding target unit from the parameter candidate list, based on the parameter information decoded by the parameter information decoder, and decode the decoding target unit using the parameter, wherein the image decoder continues decoding the encoded stream even when the error may be detected by the error detecting unit.

In this way, even when the error occurred, stoppage of the decoding process is prevented. Accordingly, a harmful effect caused by the error is reduced.

In addition, for example, when the error may be detected by the error detecting unit, the image decoder continues decoding the encoded stream by concealing the error.

In this way, even when the error occurred, the error is concealed. Accordingly, a harmful effect caused by the error is reduced.

In addition, for example, when the error may be detected by the error detecting unit, the image decoder conceals the error by identifying an alternative parameter from the parameter candidate list, and decoding the decoding target unit using the alternative parameter.

In this way, the alternative parameter identified from the list is used. Accordingly, the error is concealed appropriately.

In addition, for example, when the error may be detected by the error detecting unit, the image decoder may conceal the error by decoding the decoding target unit using a predetermined alternative parameter.

In this way, the predetermined alternative parameter is used. Accordingly, the error is concealed appropriately.

In addition, for example, when the error may be detected by the error detecting unit, the image decoder may continue decoding the encoded stream by decoding a unit different from the decoding target unit.

In this way, the unit with no error is decoded. Accordingly, a harmful effect caused by the error is reduced.

Furthermore, an image decoding device according to an aspect of the present invention is an image decoding device which decodes an encoded stream of images each divided into a plurality of units, the image decoding device including: a parameter candidate generating unit configured to generate a parameter candidate list including one or more parameter candidates each of which is available to decode a decoding target unit, using one or more parameters used in decoding of one or more decoded units; a parameter information decoder which decodes parameter information included in the encoded stream and related to the one or more parameter candidates; and an image decoder which identifies a parameter to be used to decode the decoding target unit from the parameter candidate list, based on the parameter information decoded by the parameter information decoder, and decodes the decoding target unit using the parameter, wherein the image decoder continues decoding the encoded stream even when the parameter information decoded by the parameter information decoder does not have a match in the parameter candidate list generated by the parameter candidate generating unit.

In this way, even when the parameter candidate list and the parameter information do not match each other, decoding is continued. Accordingly, the error resilience is increased.

For example, when the parameter information does not have a match in the parameter candidate list, the image decoder may continue decoding the encoded stream by decoding the decoding target unit using an alternative parameter.

In this way, when the parameter candidate list and the parameter information do not match each other, the alternative parameter is used. Accordingly, the image decoding device can continue decoding appropriately.

In addition, for example, when the parameter information does not have a match in the parameter candidate list, the image decoder may continue decoding the encoded stream by decoding a unit different from the decoding target unit.

In this way, when the parameter candidate list and the parameter information do not match each other, another unit is decoded. Accordingly, the image decoding device can continue decoding appropriately.

These general and specific aspects may be implemented using a system, a method, an integrated circuit, a computer program, or a computer-readable recording medium such as a non-transitory computer-readable recording medium such as a CD-ROM, or any combination of systems, methods, integrated circuits, computer programs, or recording media.

Hereinafter, embodiments of the present invention are described in detail with reference to the Drawings. Each of the embodiments below describes a general or specific example. The numerical values, shapes, materials, structural elements, the arrangement and connection of the structural elements, steps, the processing order of the steps etc. shown in the following exemplary embodiments are mere examples, and therefore do not limit the scope of the appended Claims and their equivalents. Therefore, among the structural elements in the following exemplary embodiments, structural elements not recited in any one of the independent claims are described as arbitrary structural elements.

In addition, expressions of 64×64 pixels, 32×32 pixels etc. respectively mean the size of 64×64 pixels, the size of 32×32 pixels, etc.

In addition, hereinafter, expressions such as a block, a data unit, a coding unit (CU), etc. respectively mean continuous areas. The respective areas may mean image areas. Alternatively, the respective areas may mean data areas in an encoded stream.

In addition, one or more images may be a still image, a plurality of pictures constituting a video, a picture, a part of a picture, and/or the like.

In addition, decoding a unit means decoding an image inside the unit. Decoding may include variable length decoding, inverse quantization, inverse frequency transform, prediction, reconstruction, and filtering.

### Embodiment 1

First, the outline of an image decoding device according to an embodiment is described. The image decoding device according to this embodiment decodes an encoded stream including a prediction unit encoded through prediction, using a prediction parameter candidate list and a prediction parameter identification information.

At this time, the image decoding device determines whether or not the prediction parameter candidate list includes the prediction parameter candidate indicated by the prediction parameter identification information, and detects, as an error, a state in which the prediction parameter candidate list does not include the prediction parameter candidate indicated by the prediction parameter identification information.

In this way, the image decoding device can detect such an error for each prediction unit, and thus can increase the error resilience.

The outline of the image decoding device according to this embodiment has been described above.

Next, a structure of the image decoding device according to an embodiment is described.

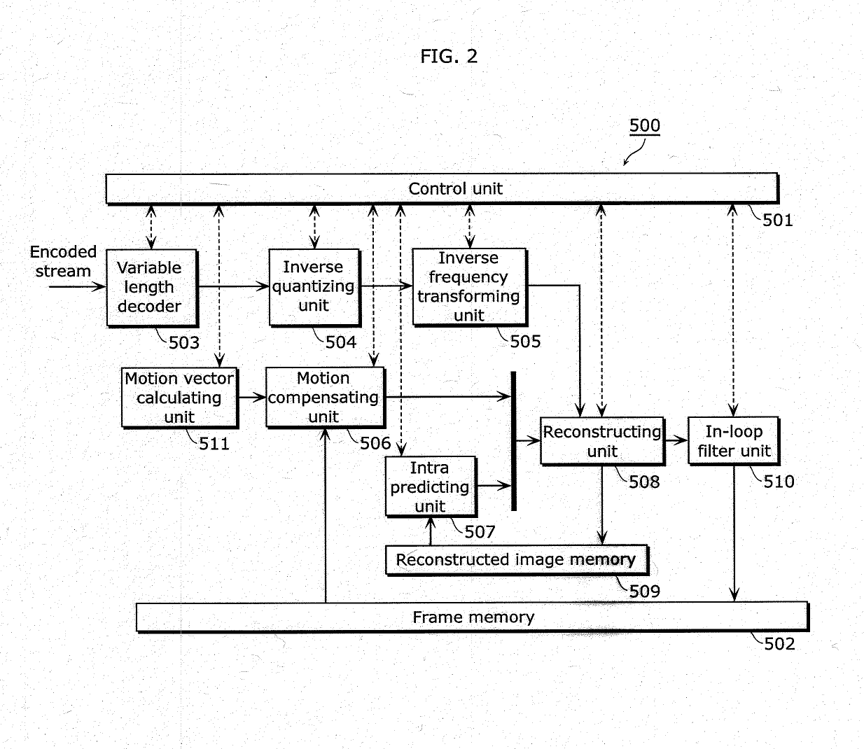

FIG. 2 is a block diagram illustrating the structure of the image decoding device according to this embodiment. As illustrated in FIG. 2, the image decoding device 500 according to this embodiment includes: a control unit 501; a frame memory 502; a reconstructed image memory 509; a variable length decoder 503; an inverse quantizing unit 504; an inverse frequency transforming unit 505; a motion compensating unit 506; an intra predicting unit 507; a reconstructing unit 508; an in-loop filter unit 510; and a motion vector calculating unit 511.

The control unit 501 controls the whole image decoding device 500. The frame memory 502 is a memory for storing decoded image data. The reconstructed image memory 509 is a memory for storing part of the generated reconstructed image.

The variable length decoder 503 reads the encoded stream and decodes the variable length codes. In addition, the variable length decoder 503 functions as a parameter information decoder and decodes parameter information that is included in the encoded stream and related to parameter candidates. For example, the parameter information is motion vector predictor candidate information (identification numbers) for identifying a motion vector predictor.

The inverse quantizing unit 504 performs inverse quantization on the decoded coefficient information to reconstruct frequency coefficients. The inverse frequency transforming unit 505 transforms the frequency coefficients into a difference image by performing inverse frequency transform such as inverse discrete cosine transform on the frequency coefficients.

The motion vector calculating unit 511 functions as a parameter candidate generating unit, and generates a parameter candidate list. For example, the motion vector calculating unit 511 generates a motion vector predictor candidate list, using motion vectors used in decoded prediction units neighboring a decoding target prediction unit. The motion vector predictor candidate list includes motion vector predictor candidates which are candidates for motion vector predictor(s) to be used in decoding the decoding target prediction unit.

In addition, the motion vector calculating unit 511 identifies a motion vector predictor from the motion vector predictor candidate list. The motion vector calculating unit 511 then calculates a motion vector using the identified motion vector predictor. Mores specifically, the motion vector calculating unit 511 calculates a motion vector by adding the motion vector predictor and the motion vector difference. The motion vector calculating unit 511 then outputs the calculated motion vector to the motion compensating unit 506.

In addition, the motion vector calculating unit 511 functions as an error detecting unit, and detects an error by determining whether or not the motion vector predictor candidate list includes the motion vector predictor identified by the motion vector predictor candidate identification information.

It is to be noted that each of the motion vector, motion vector predictor, and motion vector predictor candidate may be combined with reference picture information. For example, the motion vector predictor candidate list may include the reference picture information corresponding to the motion vector predictor candidates, together with the motion vector predictor candidates. In addition, the motion vector calculating unit 511 may identify the reference picture information corresponding to the motion vector predictor, together with the motion vector predictor.

The motion compensating unit 506 reads a reference image from the frame memory 502, performs motion compensation to generate a prediction image. The intra predicting unit 507 reads a reference image from the reconstructed image memory 509, and performs intra-frame prediction (also referred to as intra prediction) to generate a prediction image. The reconstructing unit 508 generates a reconstructed image by adding the difference image and the prediction image, and stores part of the reconstructed image into the reconstructed image memory 509. The in-loop filter unit 510 removes block noise from the reconstructed image to enhance the image quality of the reconstructed image.

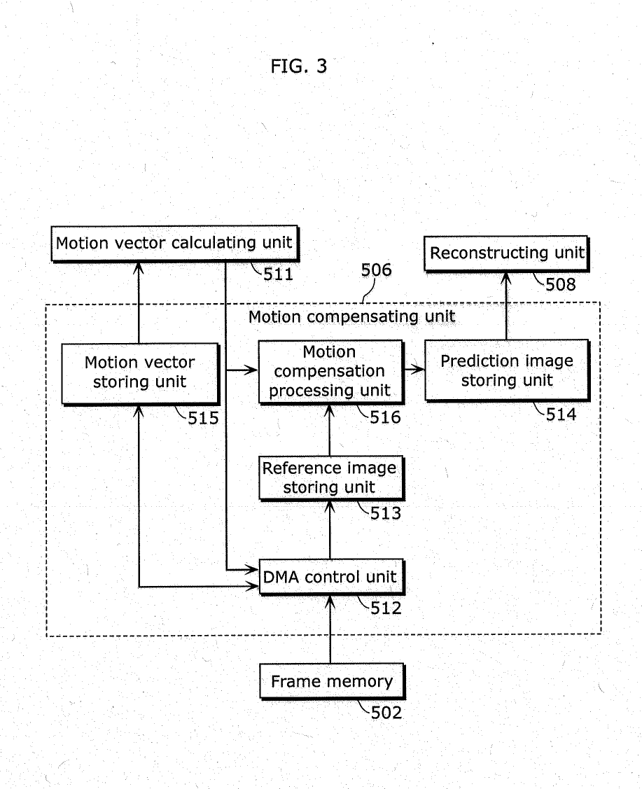

FIG. 3 is a block diagram illustrating a configuration neighboring the motion compensating unit 506 according to this embodiment. The same structural elements as in FIG. 2 are assigned with the same numerical references, and descriptions thereof are not repeated. As illustrated in FIG. 3, the motion compensating unit 506 according to this embodiment includes: a Direct Access Memory (DMA) control unit 512; a reference image storing unit 513; a prediction image storing unit 514; a motion vector storing unit 515; and a motion compensation processing unit 516.

The DMA control unit 512 stores colPU information to the motion vector storing unit 515 by transferring the colPU information from the frame memory 502 to the motion vector storing unit 515, based on the coordinates of the decoding target prediction unit and the size information thereof. In addition, the DMA control unit 512 stores a reference image to the reference image storing unit 513 by transferring the reference image indicated by the motion vector calculated by the motion vector calculating unit 511 from the frame memory 502 to the reference image storing unit 513. In addition, the motion compensation processing unit 516 stores the generated prediction image in the prediction image storing unit 514.

The structure of the image decoding device 500 according to this embodiment has been described above.

Next, a structure of an encoded stream that is decoded by the image decoding device 500 according to an embodiment is described. The encoded stream that is decoded by the image decoding device 500 includes coding units (CU), transform units (TU), and prediction units (PU).

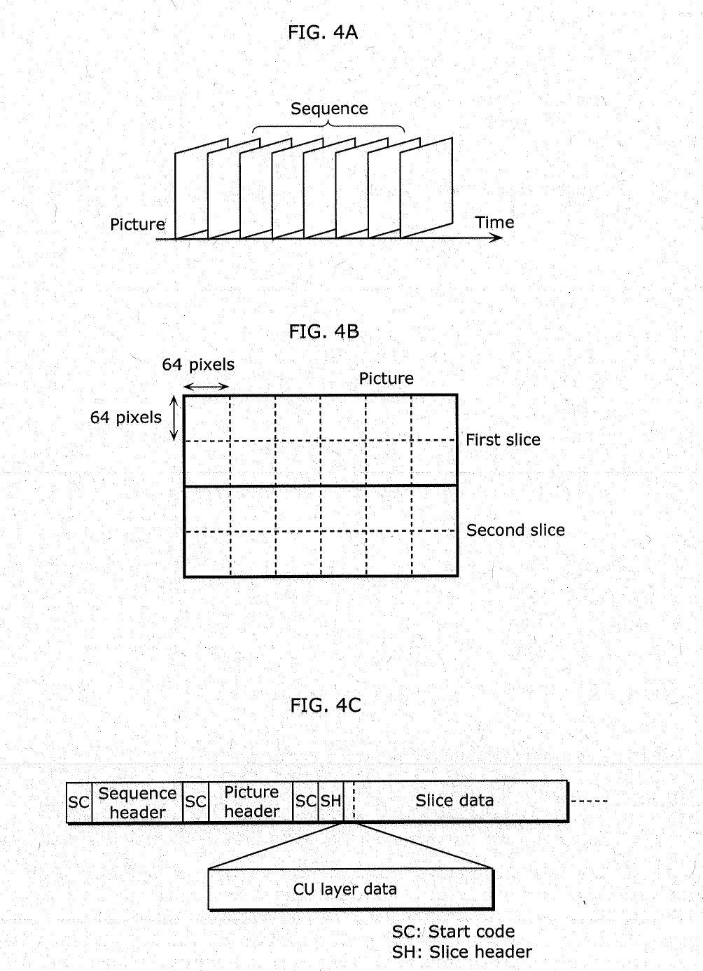

A coding unit (CU) has a size selected from 64×64 pixels to 8×8 pixels, and is a data unit based on which intra prediction and inter prediction can be switched. A transform unit (TU) has a size selected from 32×32 pixels to 4×4 pixels inside a coding unit (CU). A prediction unit (PU) has a size selected from 64×64 pixels to 4×4 pixels inside a coding unit (CU), and includes either an intra prediction mode or a motion vector in inter prediction. Hereinafter, a structure of an encoded stream is described with reference to FIG. 4A to FIG. 6C.

FIG. 4A is a diagram illustrating an example of a sequence according to this embodiment, and FIG. 4B is a diagram illustrating an example of a picture. As illustrated in FIG. 4A, a group of pictures is called a sequence. In addition, as illustrated in FIG. 4B, each picture is divided into slices, and each slice is further divided into coding units (CU). Each picture may be divided into slices.

In this embodiment, the size of the largest coding unit (LCU) is 64×64 pixels.

FIG. 4C is a diagram illustrating an example of an encoded stream according to this embodiment. Hierarchical data illustrated in FIGS. 4A and 4B are encoded into an encoded stream illustrated in FIG. 4C.

The encoded stream illustrated in FIG. 4C includes a sequence header for controlling the sequence, a picture header for controlling a picture, a slice header for controlling a slice, and a coding unit layer (CU layer data). It is to be noted that, in the H.264 standard, a sequence header is referred to as a Sequence Parameter Set (SPS), and a picture header is referred to as a Picture Parameter Set (PPS).

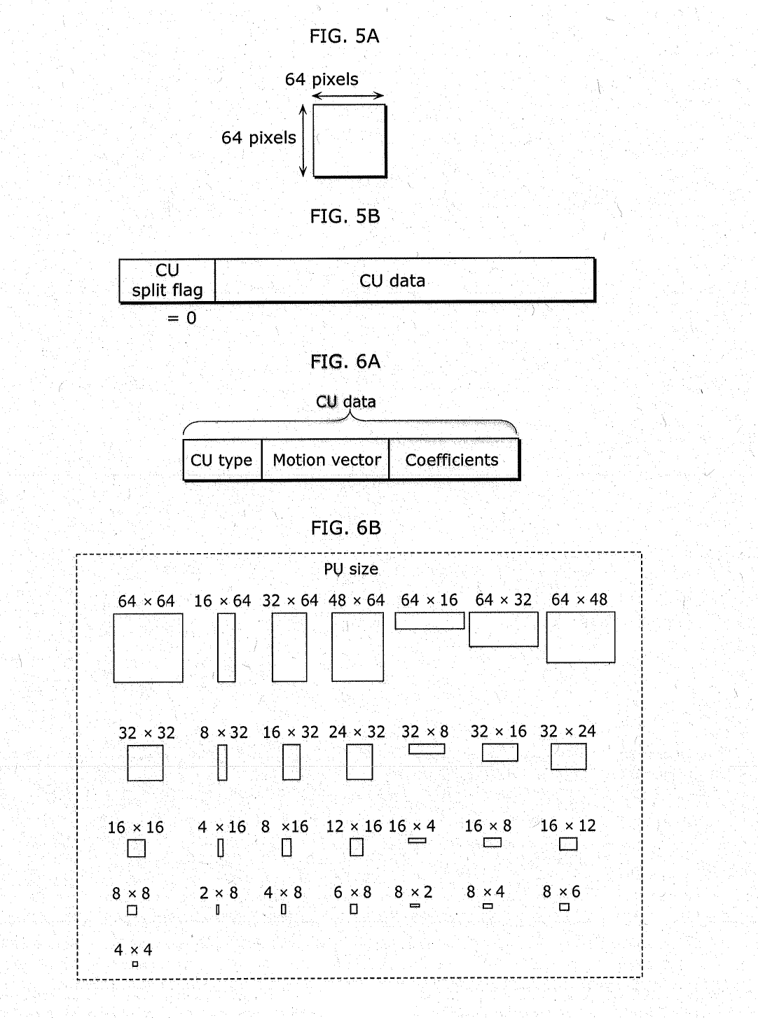

Next, structures of a coding unit and an encoded stream which are used for descriptions in this embodiment are described with reference to FIG. 5A and FIG. 5B. FIG. 5A is a diagram illustrating an example of a coding unit according to this embodiment, and FIG. 5B is a diagram illustrating an example of coding unit layer data of an encoded stream.

As illustrated in FIG. 5B, the coding unit layer data of the encoded stream includes a CU split flag and CU data. The CU split flag indicates division into four blocks when a value thereof is “1”, and indicates no division into four blocks when a value thereof is “0”. The coding unit of 64×64 pixels illustrated in FIG. 5A is not divided. Accordingly, the CU split flag indicates “0”.

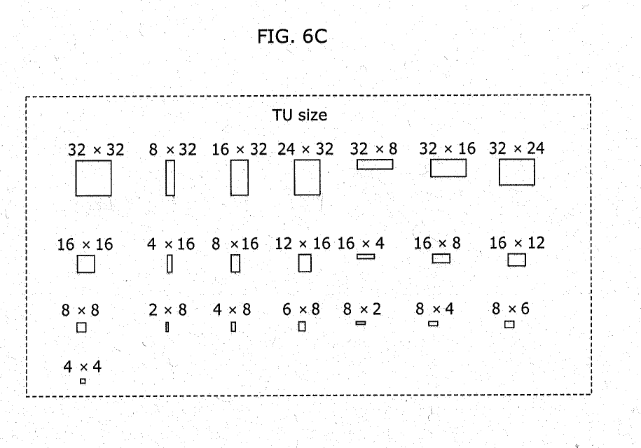

Next, CU data is described. FIG. 6A is a diagram illustrating an example of the CU data according to Embodiment 1. FIG. 6B is a diagram illustrating examples of prediction unit sizes according to this embodiment. FIG. 6C is a diagram illustrating examples of transform unit sizes according to this embodiment.

As illustrated in FIG. 6A, the CU data includes a CU type, and further includes either a motion vector or an intra prediction mode. The size of the prediction unit may be determined depending on the type of a CU.

As illustrated in FIG. 6B, the sizes selectable for prediction units are, for example, 64×64 pixels, 16×64 pixels, 32×64 pixels, 48×64 pixels, 64×16 pixels, 64×32 pixels, 64×48 pixels, 32×32 pixels, 8×32 pixels, 16×32 pixels, 24×32 pixels, 32×8 pixels, 32×16 pixels, 32×24 pixels, 16×16 pixels, 4×16 pixels, 8×16 pixels, 12×16 pixels, 16×4 pixels, 16×8 pixels, 16×12 pixels, 8×8 pixels, 2×8 pixels, 4×8 pixels, 6×8 pixels, 8×2 pixels, 8×4 pixels, 8×6 pixels, pixels, and 4×4 pixels.

In this way, the size of a prediction unit can be selected from among the size of 4×4 pixels and larger sizes. In addition, the shape of the prediction unit may be rectangular. Either a motion vector or an intra prediction mode is specified for each prediction unit. In this embodiment, only a motion vector is used. Thus, only the motion vector is illustrated in the example of FIG. 6A. In addition, as illustrated in FIG. 6B, prediction units of 16×64 pixels, 48×64 pixels, etc. obtainable by dividing a square in a ratio of 1:3 can be selected.

As illustrated in FIG. 6C, the sizes selectable for transform units are, for example, 32×32 pixels, 8×32 pixels, 16×32 pixels, 24×32 pixels, 32×8 pixels, 32×16 pixels, 32×24 pixels, 16×16 pixels, 4×16 pixels, 8×16 pixels, 12×16 pixels, 16×4 pixels, 16×8 pixels, 16×12 pixels, 8×8 pixels, 2×8 pixels, 4×8 pixels, 6×8 pixels, 8×2 pixels, 8×4 pixels, 8×6 pixels, and 4×4 pixels. As illustrated in FIG. 6C, transform units of 8×32 pixels, 24×32 pixels, etc. obtainable by dividing a square in a ratio of 1:3 can be selected.

It is to be noted that the sizes of the prediction units and the sizes of the transform units described above are examples. The sizes for prediction units and the sizes for transform units are not limited to the sizes of the prediction units and the sizes of the transform units described above.

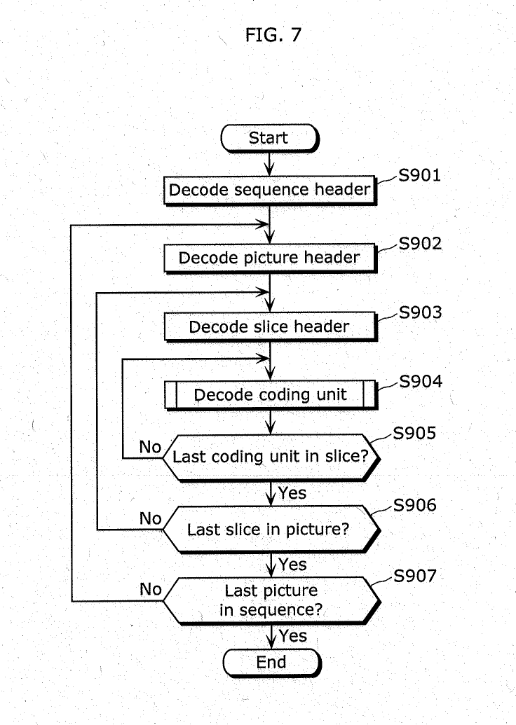

Next, operations by the image decoding device 500 illustrated in FIG. 2 are described with reference to a flowchart illustrated in FIG. 7. FIG. 7 is a flowchart of decoding operations on a single sequence included in an encoded stream.

As illustrated in FIG. 7, the image decoding device 500 decodes a sequence header (S901). More specifically, the variable length decoder 503 decodes a sequence header included in the encoded stream, under control by the control unit 501. Next, the image decoding device 500 decodes a picture header (S902), and decodes a slice header (S903).

Next, the image decoding device 500 decodes a coding unit (S904). Decoding of a coding unit is described in detail later. After the decoding of the coding unit, the image decoding device 500 determines whether or not the decoded coding unit is the last coding unit in a slice (S905). When the decoded coding unit is not the last coding unit in the slice (No in S905), the image decoding device 500 decodes a next coding unit (S904).

Furthermore, when the decoded coding unit is the last coding unit in the slice (Yes in S905), the image decoding device 500 determines whether or not the slice including the decoded coding unit is the last slice in a picture (S906). When the slice is not the last slice in the picture (Yes in S906), the image decoding device 500 decodes a next slice header (S903).

Furthermore, when the slice is the last slice in the picture (Yes in S906), the image decoding device 500 determines whether or not the picture including the decoded coding unit is the last picture in a sequence (S907). When the picture is not the last picture in the sequence (No in S907), the image decoding device 500 decodes a next picture header (S902). The image decoding device 500 finishes the sequence of decoding operations after the decoding of all of the pictures in the sequence.

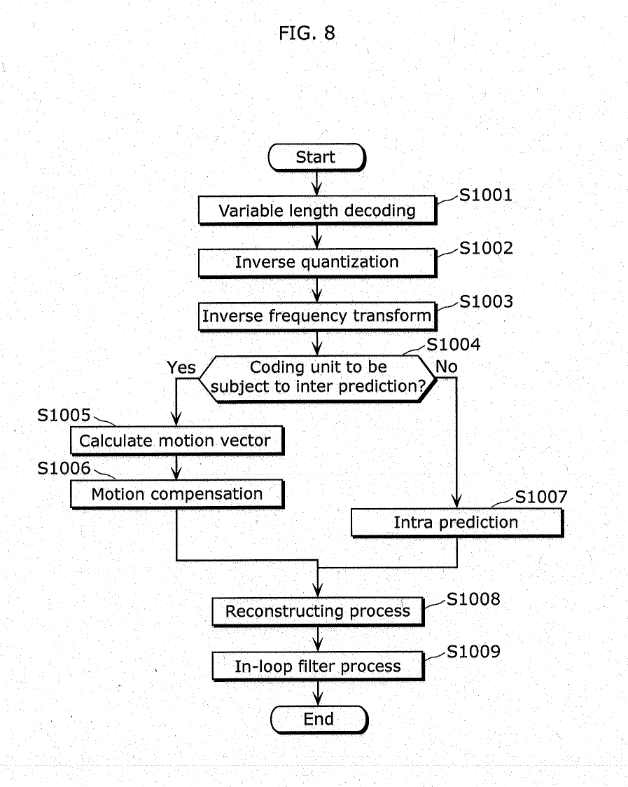

Next, a decoding operation (S904) on the coding unit in FIG. 7 is described with reference to the flowchart illustrated in FIG. 8. FIG. 8 is a flowchart of decoding operations on the single coding unit.

First, the variable length decoder 503 performs variable length decoding on the processing target coding unit included in the input encoded stream (S1001).

The variable length decoder 503 then outputs coding information obtained through the variable length decoding. For example, the coding information includes a coding unit type, an intra-frame prediction (intra prediction) mode, a motion vector, a quantization parameter, the size and processing order of the coding unit, the size and processing order of a prediction unit, and the size and processing order of a transform unit. Furthermore, the variable length decoder 503 outputs coefficient information corresponding to data of each pixel.

The coding information is output to the control unit 501, and then is input to each of the processing units. Coefficient information is output to the inverse quantizing unit 504. Next, the inverse quantizing unit 504 performs an inverse quantization process on the coefficient information to reconstruct frequency coefficients (S1002). Consequently, the inverse frequency transforming unit 505 generates a difference image by performing inverse frequency transform on the frequency coefficients (S1003).

Next, the control unit 501 determines which one of the inter prediction and intra prediction is used for the processing target coding unit (S1004).

When inter prediction is used (Yes in S1004), the control unit 501 activates the motion vector calculating unit 511. The motion vector calculating unit 511 then calculates a motion vector, and transfers the reference image indicated by the calculated motion vector from the frame memory 502 to the reference image storing unit 513. Next, the control unit 501 activates the motion compensating unit 506. The motion compensating unit 506 generates a prediction image having a ½ pixel accuracy or a ¼ pixel accuracy (S1006).

On the other hand, when inter prediction is not used (No in S1004), that is, when intra prediction is used, the control unit 501 activates the intra predicting unit 507. Next, the intra predicting unit 507 performs intra prediction to generate a prediction image (S1007).

The reconstructing unit 508 generates a reconstructed image by adding the prediction image output by either the motion compensating unit 506 or the intra predicting unit 507 and the difference image output by the inverse frequency transforming unit 505 (S1008).

The resulting reconstructed image is input to the in-loop filter unit 510. At the same time, the part that is used in intra prediction in the reconstructed image is stored in the reconstructed image memory 509. Lastly, the in-loop filter unit 510 performs an in-loop filter process for reducing block noise on the resulting reconstructed image. The in-loop filter unit 510 then stores the reconstructed image through the in-loop filter process into the frame memory 502 (S1009). Decoding operations on the coding unit are finished above.

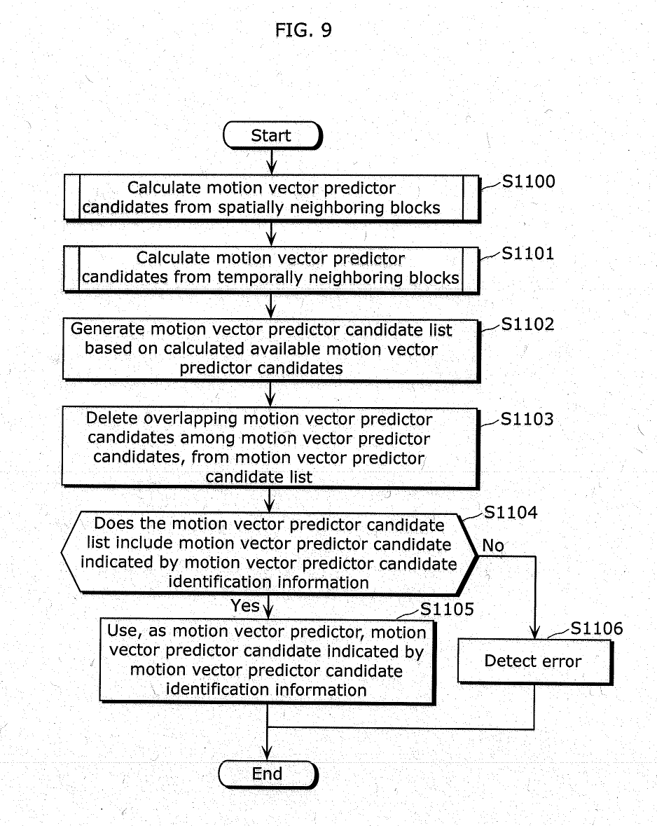

Next, operations by the motion vector calculating unit 511 are described in detail. FIG. 9 is a flowchart of operations performed by the motion vector calculating unit 511 to detect an error.

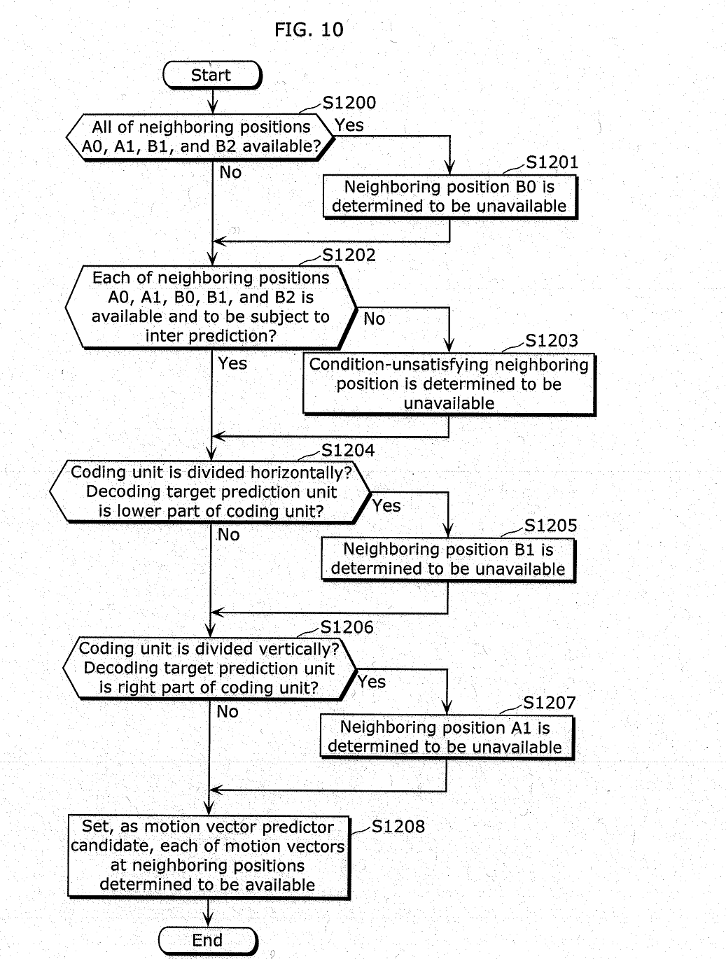

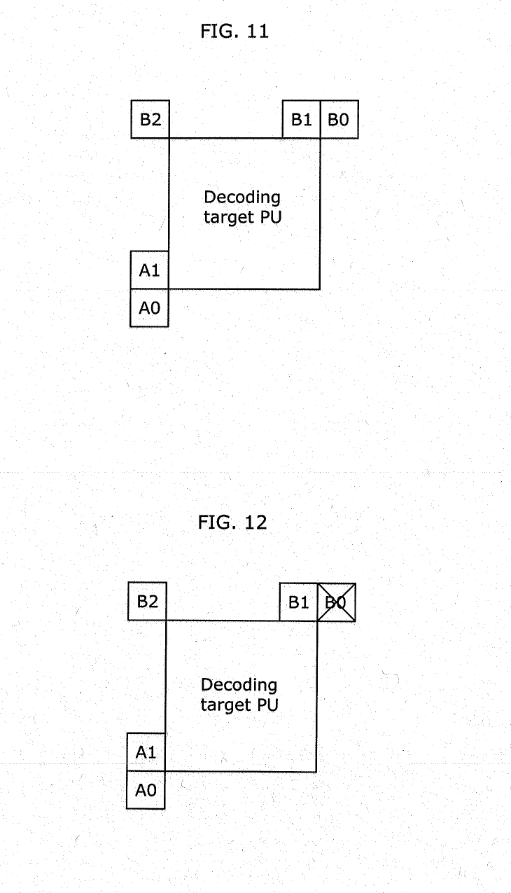

First, the motion vector calculating unit 511 calculates motion vector predictor candidates from decoded spatially neighboring prediction units (S1100). FIG. 10 is a flowchart of operations for calculating motion vector predictors from the decoded spatially neighboring prediction units. In addition, FIG. 11 is a diagram indicating a relationship between a decoding target prediction unit and spatially neighboring prediction units thereof.

More specifically, motion vectors that are used when the motion vector predictor candidates are calculated from the decoded spatially neighboring prediction units are motion vectors in PUs including pixels located at the down left (A0), left (A1), diagonal upper right (B0), upper (B1), or diagonal upper left (B2) position with respect to the decoding target prediction unit illustrated in FIG. 11. In the calculation of the motion vector predictor candidates, the following may be used: a reference picture corresponding to a motion vector in a PU, and information of a prediction mode indicating which one of the intra prediction and the motion compensation is used to encode the PU.

First, the motion vector calculating unit 511 determines whether or not all of the motion vectors in the neighboring positions A0, A1, B1, and B2 are available (S1200). Here, when all of the motion vectors in the prediction units are available (Yes in S1200), the motion vector calculating unit 511 determines that a motion vector at the neighboring position B0 is unavailable (S1201).

Next, the motion vector calculating unit 511 determines whether each of the neighboring positions A0, A1, B0, B1, and B2 is available and to be subject to inter prediction (S1202). Here, when the prediction unit is unavailable or to be subject to intra prediction (No in S1202), the motion vector calculating unit 511 determines that the motion vector of the condition-unsatisfying prediction unit to be unavailable (S1203).

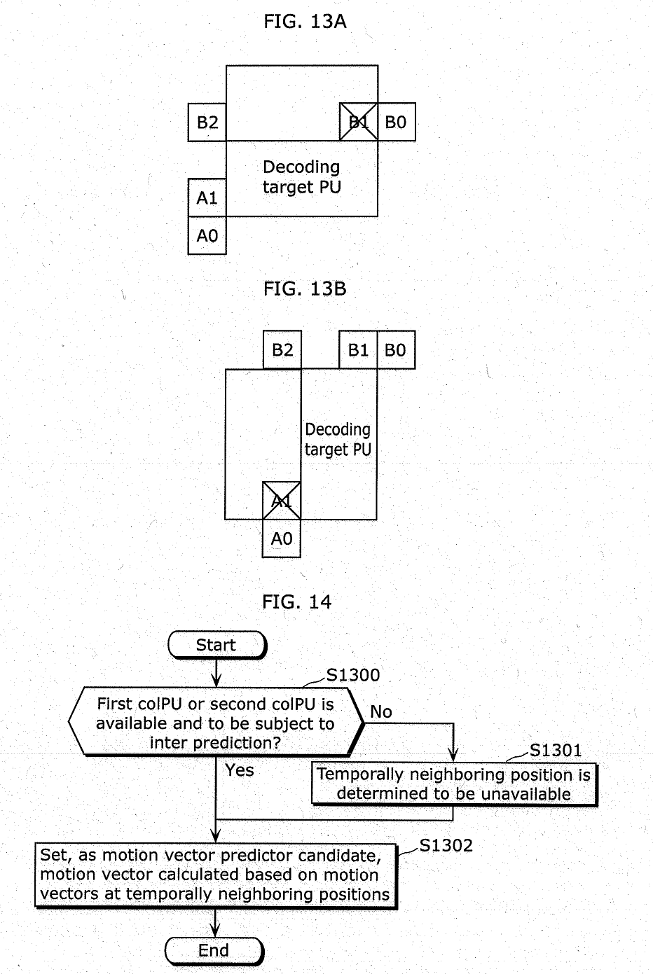

Next, the motion vector calculating unit 511 determines whether the coding unit including the decoding target prediction unit is divided horizontally and the prediction unit of the decoding target block is the lower part of the coding unit (S1204). Here, when the coding unit including the decoding target prediction unit is divided horizontally and the prediction unit of the decoding target block is the lower part of the coding unit (Yes in S1204), the motion vector calculating unit 511 determines that the motion vector of the neighboring position B1 to be unavailable as illustrated in FIG. 13 (S1205).

Next, the motion vector calculating unit 511 determines whether the coding unit including the decoding target prediction unit is divided vertically and the prediction unit of the decoding target block is the right part of the coding unit (S1206). Here, when the coding unit including the decoding target prediction unit is divided vertically and the prediction unit of the decoding target block is the right part of the coding unit (Yes in S1206), the motion vector calculating unit 511 determines that the motion vector of the neighboring prediction unit A1 to be unavailable as illustrated in FIG. 13B (S1207).

Next, the motion vector calculating unit 511 sets, to be motion vector predictor candidates, the respective motion vectors which are not determined to be unavailable in the processes in S1200 to S1207 (S1208).

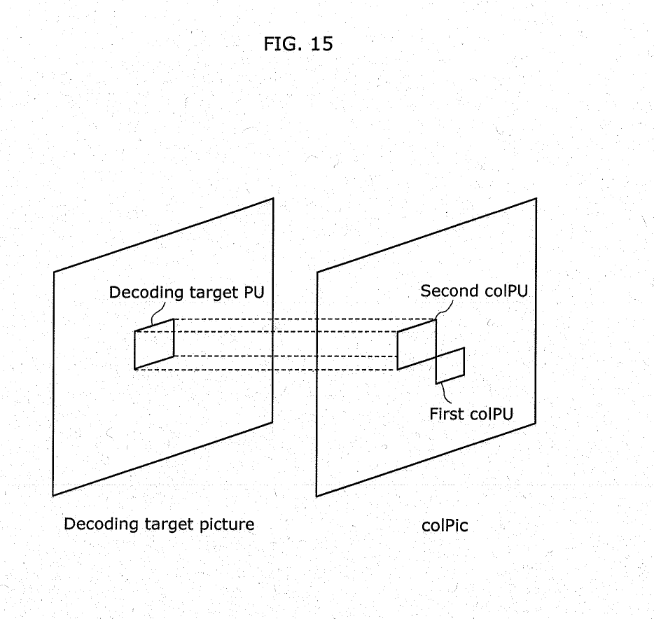

Next, the motion vector calculating unit 511 calculates motion vector predictor candidates from decoded temporally neighboring prediction units (S1101). FIG. 14 is a flowchart of operations for calculating motion vector predictors from the decoded temporally neighboring prediction units. In addition, FIG. 15 is a diagram indicating a relationship between the decoding target prediction unit and the temporally neighboring prediction units thereof.

More specifically, a motion vector which is used to calculate the motion vector predictor candidates from the decoded temporally neighboring prediction units is a motion vector in either a first colPU or a second colPIC illustrated in FIG. 15. The first colPU is a prediction unit located at coordinates neighboring the decoding target prediction unit in a temporally neighboring picture (hereinafter also referred to as a colPic) with respect to the decoding target picture. The second colPU in the colPic is a prediction unit located at the same coordinates as those of the decoding target prediction unit.

In the calculation of the motion vector predictor candidates, it is also good to use a reference picture corresponding to a motion vector in a PU, and information of a prediction mode indicating which one of the intra prediction and the motion compensation is used to encode the PU.

Firstly, the motion vector calculating unit 511 determines whether or not one of the first colPU and the second colPU is available and to be subject to inter prediction (S1300). Here, when the first colPU and the second colPU are unavailable or to be subject to intra prediction (No in S1300), the motion vector calculating unit 511 determines the motion vector located at the temporally neighboring position to be unavailable (S1301).

Next, the motion vector calculating unit 511 calculates a motion vector predictor from the motion vector of the temporally neighboring prediction unit, and sets the calculated prediction motion vector to be a motion vector predictor candidate (S1302).

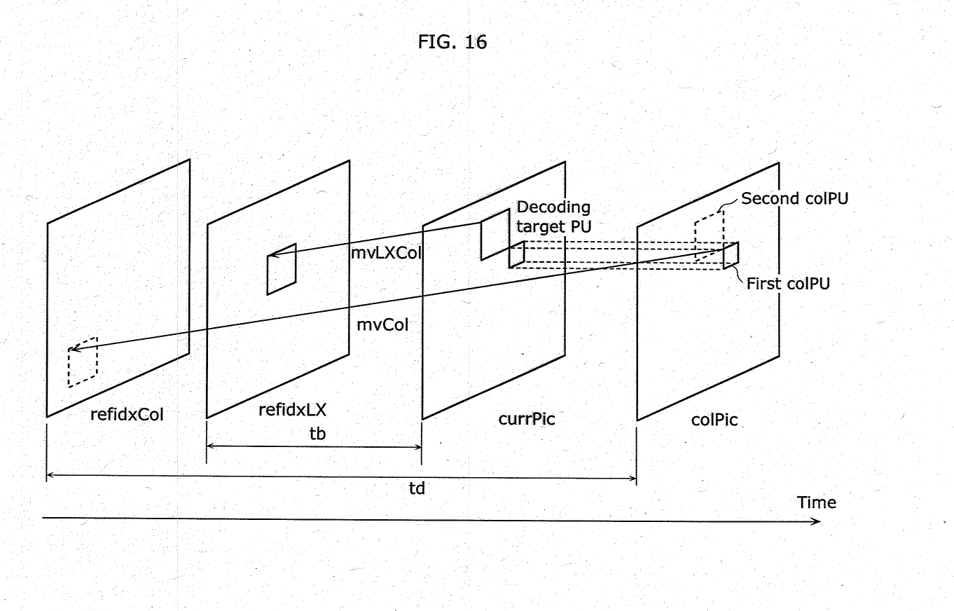

FIG. 16 is a diagram illustrating an example of a method of calculating a motion vector predictor from motion vectors located at temporally neighboring positions.

A motion vector predictor mvLXCol illustrated in FIG. 16 is calculated according to Expression 2 when Expression 1 below is satisfied.

PicOrderCnt(colPic)−RefPicOrderCnt(refIdxCol,ListCol)=PicOrderCnt(currPic)−RefPicOrderCnt(refIdxLX,LX)[ (Expression 1)

mvLXCol=mvCol (Expression 2)

In addition, when Expression 1 above is not satisfied, the motion vector predictor mvLXCol is calculated according to Expression 3 to Expression 8 below.

tx=(16384+Abs(td/2))/td (Expression 3)

DistScaleFactor=Clip3(−1024,1023,(tb*tx+32)>>6) (Expression 4)

mvLXCol=ClipMv(Sign(DistScaleFactor*mvLXA)*((Abs(DistScaleFactor*mvCol)+128)>>8)) (Expression 5)

td=Clip3(−128,127,PicOrderCnt(colPic)−RefPicOrderCnt(refIdxCol,ListCol)) (Expression 6)

tb=Clip3(−128,127,PicOrderCnt(currPic)−RefPicOrderCnt(refIdxLX,LX)) (Expression 7)

$$\begin{matrix}[ Math . 1 ] & \\ Clip 3 ( A , B , C ) = \{ \begin{matrix}A ; C < A \\ B ; C > B \\ C ; Others\end{matrix} & ( Expression 8 )\end{matrix}$$

Here, PicOrderCnt(X) indicates a display order of Picture X. In addition, RefPicORderCnt (refidxY, a reference direction Z) indicates a display order of a reference image identified by the refidxY in the reference direction Z.

Next, the motion vector calculating unit 511 generates a motion vector predictor candidate list using available ones of a plurality of motion vector predictor candidates calculated from spatially neighboring prediction units and temporally neighboring prediction units (S1102).

For example, the motion vector calculating unit 511 adds, to the motion vector predictor candidate list, motion vectors of PUs as motion vector predictor candidates in the following listed order of A1, B1, B0, B2, and Col. The motion vector predictor candidates are assigned with identification numbers starting with 0 in the order of the addition to the motion vector predictor candidate list.

Next, the motion vector calculating unit 511 deletes overlapping motion vectors from the motion vector predictor candidate list (S1103). For example, the motion vector calculating unit 511 preferentially deletes, from the motion vector prediction candidate list, a prediction motion vector candidate having a larger identification number.

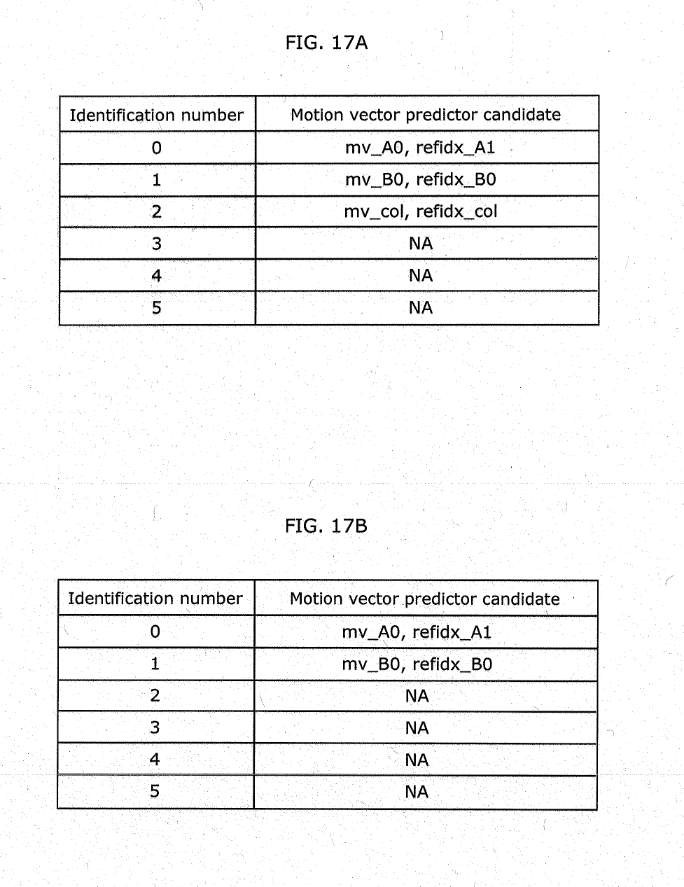

More specifically, the motion vector predictor candidate list illustrated in FIG. 17A is generated. When a motion vector predictor (mv_B0) of B0 is identical to a motion vector predictor (mv_col) of Col, the motion vector predictor (mv_col) of Col is deleted from the motion vector prediction candidate list. At this time, the following condition may be added: an index (refidx_B0) indicating a reference picture of a prediction unit of B0 is identical to an index (refidx_c0l) indicating a reference picture of a prediction unit of Col.

As a result of the deletion, a motion vector predictor candidate list illustrated in FIG. 17B is generated. It is to be noted that, in FIG. 17A and FIG. 17B, NA (Not Available) denotes a state in which a motion vector predictor candidate corresponding to an identification number is not present.

Next, the motion vector calculating unit 511 determines whether or not the motion vector predictor candidate indicated by the identification information (identification number) of the motion vector predictor candidate is present in the motion vector predictor candidate list (S1104). The identification information (identification number) of the motion vector predictor candidate is a prediction parameter information decoded by the variable length decoder 503.

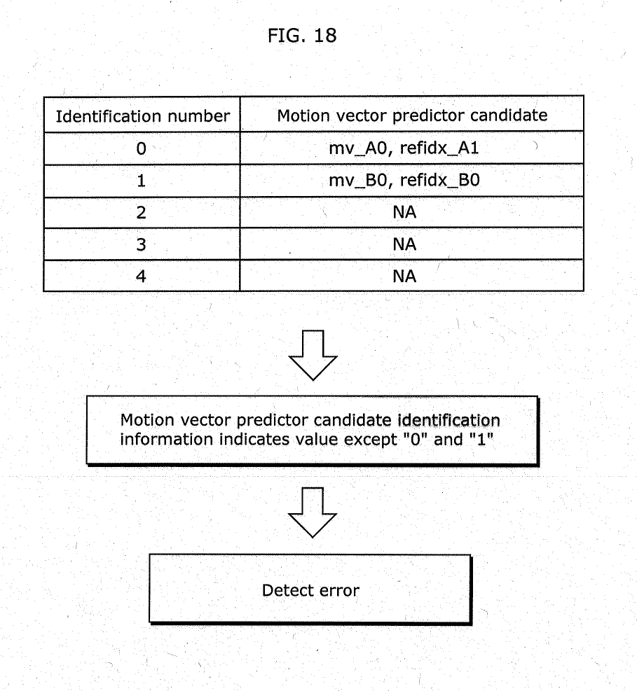

Here, when the motion vector predictor candidate indicated by the identification number is not present in the motion vector predictor candidate list (No in S1104), the motion vector calculating unit 511 detects, as an error, a state in which the motion vector predictor candidate is not present in the motion vector predictor candidate list (S1106). For example, a motion vector predictor candidate list illustrated in FIG. 18 is generated. When the identification number of a motion vector predictor candidate is a number except “0” and “1”, the motion vector calculating unit 511 detects, as an error, a state in which the motion vector predictor candidate is not present in the motion vector predictor candidate list.

On the other hand, when the motion vector predictor candidate indicated by the identification number is present in the motion vector predictor candidate list (Yes in S1104), the motion vector calculating unit 511 uses the motion vector predictor candidate indicated by the identification number as a motion vector predictor (S1105).

Through the above processes, the image decoding device 500 can detect, as an error, a state in which an appropriate motion vector predictor candidate list and the identification information of a motion vector predictor cannot be obtained due to, for example, losses of bits at the time of transmission, data replacement in other error processing, or the like. In this way, the error resilience is increased.

In this embodiment, an example of the motion compensating unit 506 is explained. However, the intra predicting unit 507 may perform similar processes. In this case, for example, an intra prediction mode or the like may be used as a prediction parameter corresponding to a motion vector. Needless to say, such a prediction parameter is not limited to the intra prediction mode.

In addition, an example of a prediction unit is described. However, a unit of processing does not always need to be the prediction unit. The unit of processing may be a coding unit, a transform unit, or another unit.

In addition, although the spatially neighboring prediction unit illustrated in FIG. 11 is used as a spatially neighboring prediction unit, a spatially neighboring prediction unit is not always identical to the spatially neighboring prediction unit illustrated in FIG. 11. A spatially neighboring prediction unit located at a position different from the position of the spatially neighboring prediction unit illustrated in FIG. 11 may be used.

In addition, although the temporally neighboring prediction unit is used as a temporally neighboring prediction unit illustrated in FIG. 15, a temporally neighboring prediction unit is not always identical to the temporally neighboring prediction unit illustrated in FIG. 15. A temporally neighboring prediction unit located at a position different from the position of the temporally neighboring prediction unit illustrated in FIG. 15 may be used.

For example, the spatially neighboring prediction unit and the temporally neighboring prediction unit are decoded units. When there is an error, there is a high possibility that a mismatch occurs between a list generated from decoded units and information decoded from an encoded stream. The image decoding device 500 detects an error utilizing such characteristics.

In addition, as described above, the image decoding device 500 detects, as an error, a state in which the motion vector predictor candidate indicated by the identification information of the motion vector predictor candidate is not present in the motion vector predictor candidate list. The image decoding device 500 may detect, as the error, a state in which the motion vector predictor candidate list is larger than a predetermined largest size for the motion vector predictor candidate list. The predetermined largest size may be included as prediction parameter information in the encoded stream.

In addition, the image decoding device 500 may detect, as an error, a sate in which a decoded identification number is larger than the largest size for the motion vector predictor candidate list. In addition, the image decoding device 500 may detect, as an error, a sate in which a decoded identification number is larger than the largest size for the motion vector predictor candidate list.

In addition, as for the structures of the respective processing units, part or all thereof may be realized as an exclusive hardware circuit, or may be realized as a program which is executed by a processor.

In addition, although each of the frame memory 502, the motion vector storing unit 515, the reference image storing unit 513, and the prediction image storing unit 514 are described as a memory or a storing unit, any of these may be any storing element for data storage. Any of these may be a memory, a flip-flop, a register, or the like, or may be configured differently. Furthermore, part of a memory area in a processor or a part of a cache memory may be used.

In addition, the sizes and shapes of the coding unit (CU), the prediction unit (PU), and the transform unit (TU) are examples. The sizes and shapes of the coding unit (CU), the prediction unit (PU), and the transform unit (TU) are not limited to the above examples.

### Embodiment 2

First, the outline of an image decoding device according to this embodiment is described. The image decoding device according to this embodiment decodes an encoded stream including a prediction unit encoded through prediction, using a prediction parameter candidate list and a prediction parameter identification information.

At this time, the image decoding device determines whether or not the prediction parameter candidate list includes the prediction parameter candidate indicated by the prediction parameter identification information, and detects, as an error, a state in which the prediction parameter candidate list does not include the prediction parameter candidate indicated by the prediction parameter identification information. The image decoding device then conceals the detected error.

In this way, the image decoding device detects an error on a per prediction unit basis, and conceals the detected error. Accordingly, the image decoding device can increase the error resilience.

In addition to the processes according to Embodiment 1, the image decoding device according to this embodiment performs the error concealment process, and thus is capable of continuing decoding while preventing image quality deterioration even when such an error is included.

The outline of the image decoding device according to this embodiment has been described above.

Next, a structure of the image decoding device according to an embodiment is described. FIG. 2 is a block diagram illustrating the structure of the image decoding device according to this embodiment. The image decoding device 500 according to this embodiment has a similar structure as in Embodiment 1, and the same descriptions are not repeated.

FIG. 3 is a block diagram illustrating a configuration neighboring the motion compensating unit 506 according to this embodiment. The motion compensating unit 506 according to this embodiment has a similar structure as in Embodiment 1, and the same descriptions are not repeated.

The structure of the image decoding device 500 according to this embodiment has been described above.

In this embodiment, structures of encoded streams as illustrated in FIG. 4A to FIG. 6C are used as in Embodiment 1. The whole operation flow according to this embodiment is similar to the whole operation flow according to Embodiment 1 illustrated in FIG. 7 and FIG. 8, and thus the same descriptions are not repeated.

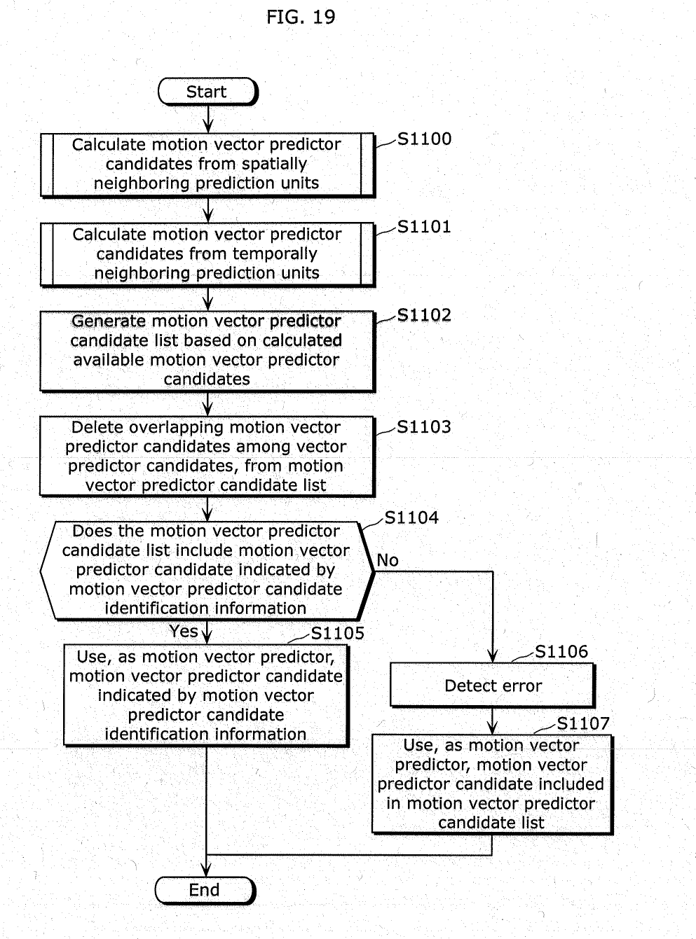

Operations by the motion vector calculating unit 511 illustrated in FIG. 3 are described with reference to FIG. 19. FIG. 19 is a flowchart of operations for error detection and error concealment in the motion vector calculating unit 511.

Operations from Step S1100 to Step S1106 are similar to those in Embodiment 1, and thus the same descriptions are not repeated.

In this embodiment, when an error is detected in Step S1106, the motion vector calculating unit 511 uses, as a motion vector predictor, one of motion vector predictor candidates in the motion vector predictor candidate list (S1107). Here, the motion vector calculating unit 511 may select the motion vector predictor candidate to be used as the motion vector predictor from the motion vector predictor candidate list in any way.

For example, the motion vector calculating unit 511 may select, as the motion vector predictor, the motion vector predictor candidate having a smallest identification number (0) assigned thereto. In addition, the motion vector calculating unit 511 may select the motion vector predictor candidate having a largest identification number assigned thereto as the motion vector predictor, from the motion vector predictor candidate list.

Through the above processes, even when the error is included, the motion vector predictor having the high spatial and temporal correlations is used. Accordingly, the image decoding device 500 can continue decoding while reducing deterioration in image quality.

In this embodiment, as an example of an error concealing method, such a motion vector predictor candidate included in the motion vector predictor candidate list is used as a motion vector predictor. However, the motion vector predictor does not always need to be such a motion vector predictor included in the motion vector predictor candidate list. For example, a predetermined fixed value may be used as a motion vector predictor. More specifically, a motion vector predictor having a magnitude of 0 may be used. In this way, a reference picture corresponding to a motion vector predictor may also be selected according to a predetermined standard.

In addition, a motion vector predictor remaining in a memory may be used. In addition, the image decoding device 500 may embed a pixel in a decoding target prediction unit in a decoded image, without using any motion vector predictor. In addition, the image decoding device 500 may skip processing until another slice is reached, may skip processing until another picture is reached, or may skip processing until another sequence is reached. In addition, the image decoding device 500 may continue decoding using another method.

In addition, in the above description, an example of motion compensation is described. However, similar processes may be applied to intra prediction. At this time, for example, an intra prediction mode or the like may be used as a prediction parameter corresponding to a motion vector predictor. Needless to say, such a prediction parameter is not limited to the intra prediction mode.

In addition, as for the structures of the respective processing units, part or all thereof may be realized as an exclusive hardware circuit, or may be realized as a program which is executed by a processor.

In addition, although each of the frame memory 502, the motion vector storing unit 515, the reference image storing unit 513, and the prediction image storing unit 514 are described as a memory or a storing unit, any of these may be any storing element for data storage. Any of these may be a memory, a flip-flop, a register, or the like, or may be configured differently. Furthermore, part of a memory area in a processor or a part of a cache memory may be used.

In addition, the sizes and shapes of the coding unit (CU), the prediction unit (PU), and the transform unit (TU) are examples. The sizes and shapes of the coding unit (CU), the prediction unit (PU), and the transform unit (TU) are not limited to the above examples.

### Embodiment 3

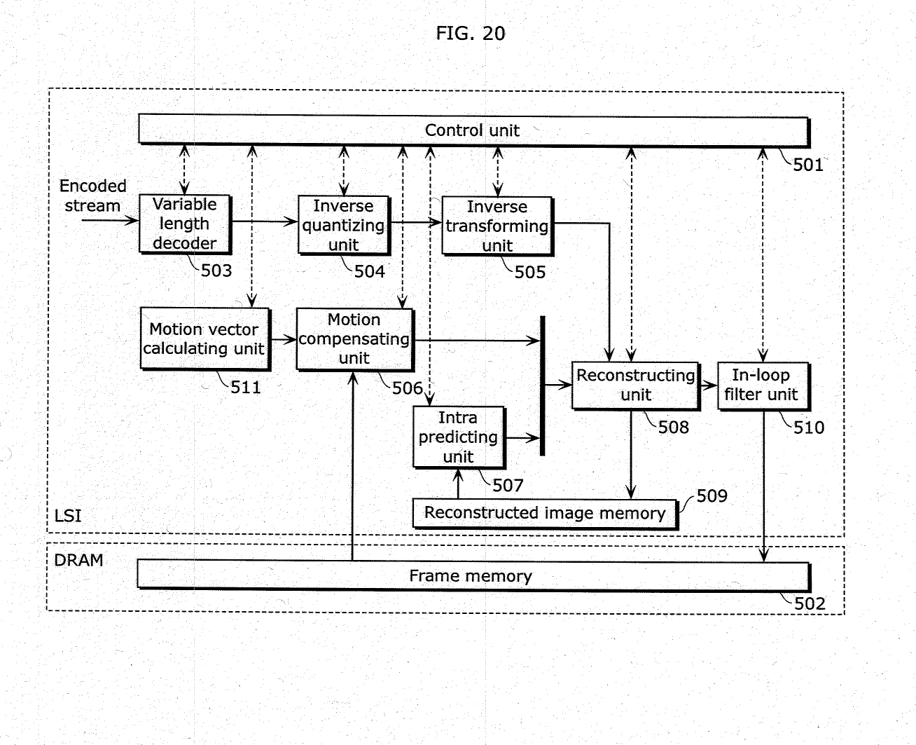

In this embodiment, the image decoding device described in Embodiment 1 is typically implemented as an LSI that is a semiconductor integrated circuit. An implemented embodiment is illustrated in FIG. 20. A frame memory 502 is implemented on a DRAM, and the other circuits and a memory are configured on an LSI.

These blocks may be made as separate individual chips, or as a single ship to include a part or all thereof. The LSI is described here, but there are instances where, due to a difference in the degree of integration, the designations IC, system LSI, super LSI, and ultra LSI are used.

Furthermore, the means for circuit integration is not limited to an LSI, and implementation with a dedicated circuit or a general-purpose processor is also available. In addition, it is also possible to use a Field Programmable Gate Array (FPGA) that is programmable after the LSI is manufactured, and a reconfigurable processor in which connections and settings of circuit cells within the LSI are reconfigurable.

Furthermore, if integrated circuit technology that replaces LSI appears thorough progress in semiconductor technology or other derived technology, that technology can naturally be used to carry out integration of the functional blocks. Biotechnology is one such possibility.

Furthermore, it is possible to configure rendering devices suitable for various kinds of applications, by combining semiconductor chips on which the image decoding device according to any of the embodiments is integrated and a display for image rendering. The present invention is applicable as an information rendering means in a mobile phone, a television receiver, a digital video recorder, a digital video camera, a car navigation system, or the like. As a display in addition to a cathode ray tube (CRT), it is possible to combine (i) a flat display such as a liquid crystal, a plasma display panel (PDP), and an organic EL, and (ii) a projector-type display represented by a projector.

In addition, the LSI in this embodiment may perform a decoding process in liaison with a dynamic random access memory (DRAM). In addition, the LSI in this embodiment may be in liaison with an embedded DRAM (eDRAM), a static random access memory (SRAM), or another memory device such as a hard disk, instead of the DRAM.

### Embodiment 4

In this embodiment, unique structures and unique procedures described in the plurality of embodiments are confirmed.

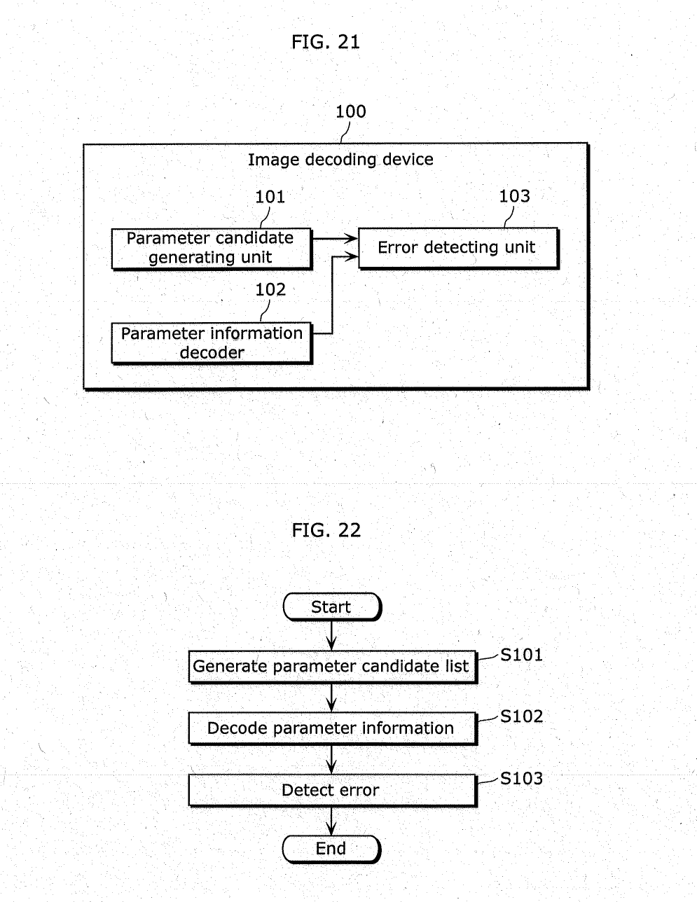

FIG. 21 is a block diagram illustrating the structure of the image decoding device according to this embodiment. The image decoding device 100 illustrated in FIG. 21 decodes an encoded stream of images each divided into a plurality of units.

More specifically, the image decoding device 100 includes a parameter candidate generating unit 101, a parameter information decoder 102, and an error detecting unit 103. For example, the parameter candidate generating unit 101 and the error detecting unit 103 illustrated in FIG. 21 correspond to the motion vector calculating unit 511 illustrated in FIG. 2. The parameter information decoder 102 illustrated in FIG. 21 corresponds to the variable length decoder 503 illustrated in FIG. 2.

FIG. 22 is a flowchart indicating operations of the image decoding device 100 illustrated in FIG. 21. First, the parameter candidate generating unit 101 generates a parameter candidate list, using one or more parameters used to decode one or more decoded units (S101). The parameter candidate list includes one or more parameter candidates each of which is a candidate for a parameter to be used to decode a decoding target unit.

Next, the parameter information decoder 102 decodes parameter information (S102). The parameter information is information included in an encoded stream and related to one or more parameter candidates.

Next, the error detecting unit 103 detects, as an error, a state in which the parameter candidate list generated by the parameter candidate generating unit 101 does not match the parameter information decoded by the parameter information decoder 102 (S103).

In this way, the image decoding device 100 is capable of detecting, as the error, the mismatch between the parameter candidate list and the parameter information. Accordingly, the error resilience is increased.

For example, each of the plurality of units is a prediction unit. The parameter candidate may be a motion vector predictor candidate, or may be an intra prediction mode candidate.

In addition, for example, the parameter information decoder 102 may decode parameter information for identifying a parameter which is used to decode a decoding target unit, from the parameter candidate list. The error detecting unit 103 may then detect, as an error, a state in which the parameter identified from the parameter information decoded by the parameter information decoder 102 is absent in the parameter candidate list.

In addition, for example, the parameter information decoder 102 may decode parameter information indicating the largest number for one or more parameter candidates. The error detecting unit 103 may then detect, as the error, a state in which the number of one or more parameter candidates included in the parameter candidate list generated by the parameter candidate generating unit 101 is larger than the largest number indicated by the parameter information decoded by the parameter information decoder 102.

In addition, for example, the parameter information decoder 102 may decode parameter information indicating the identification number of a parameter which is used to decode a decoding target unit, from the parameter candidate list. The error detecting unit 103 may then detect, as the error, a state in which the identification number indicated by the parameter information decoded by the parameter information decoder 102 is larger than the number of one or more parameter candidates included in the parameter candidate list.

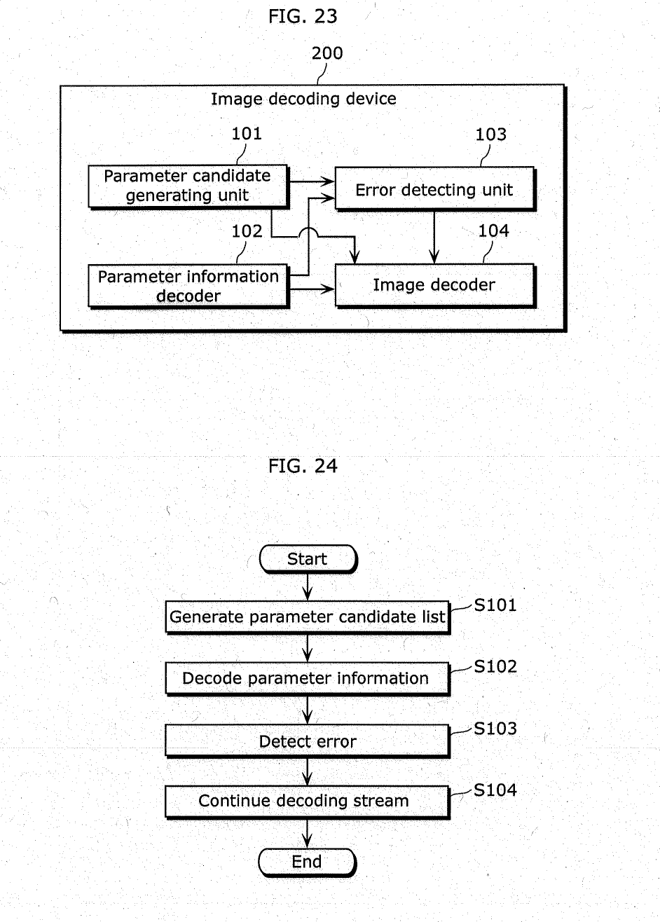

FIG. 23 is a block diagram illustrating an image decoding device according to Variation 1 of this embodiment. The image decoding device 200 illustrated in FIG. 23 additionally includes an image decoder 104, compared to the image decoding device 100 illustrated in FIG. 21.

The image decoder 104 identifies a parameter which is used to decode a decoding target unit from the parameter candidate list, based on the parameter information decoded by the parameter information decoder 102. The image decoder 104 then decodes the decoding target unit using the identified parameter. For example, the image decoder 104 corresponds to the inverse quantizing unit 504, the inverse frequency transforming unit 505, the motion compensating unit 506, the intra predicting unit 507, the reconstructing unit 508, and the like which are illustrated in FIG. 2.

FIG. 24 is a flowchart indicating operations of the image decoding device 200 illustrated in FIG. 23. The image decoding device 200 illustrated in FIG. 23 functions similarly to the image decoding device 100 until the error detecting unit 103 detects an error (S103). Next, the image decoder 104 continues decoding an encoded stream even when the error is detected by the error detecting unit 103 (S104).

For example, the image decoder 104 may continue decoding the encoded stream with error concealment, when the error is detected by the error detecting unit 103. In this case, the image decoder 104 may conceal the error by identifying an alternative parameter from the parameter candidate list and decoding the decoding target unit using the identified alternative parameter. Alternatively, the image decoder 104 may conceal the error by decoding the decoding target unit using a predetermined alternative parameter.

In addition, for example, the image decoder 104 may skip decoding the decoding target unit and decode a unit different from the decoding target unit, when the error is detected by the error detecting unit 103. In this way, the image decoder 104 may continue decoding the encoded stream.

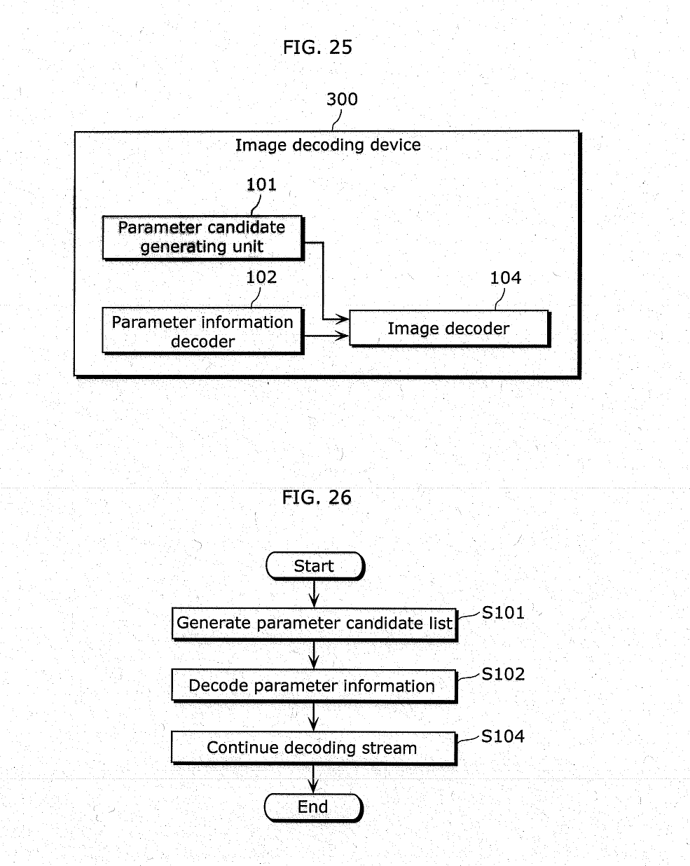

FIG. 25 is a block diagram illustrating an image decoding device according to Variation 2 of this embodiment. The image decoding device 300 illustrated in FIG. 25 does not include an error detecting unit 103, compared to the image decoding device 200 illustrated in FIG. 23. In other words, the image decoding device 300 does not always need to include the error detecting unit 103.

FIG. 26 is a flowchart indicating operations of the image decoding device 300 illustrated in FIG. 25. The image decoding device 300 illustrated in FIG. 25 operates similarly to the image decoding device 200 until the parameter information decoder 102 decodes parameter information (S102). The image decoder 104 continues decoding the encoded stream even when the parameter candidate list generated by the parameter candidate generating unit 101 does not match the parameter information decoded by the parameter information decoder 102 (S104).

For example, the image decoder 104 may continue decoding the encoded stream by decoding the decoding target unit using the alternative parameter when the parameter information does not have a match in the parameter candidate list. In addition, the image decoder 104 may skip decoding the decoding target unit and decode a unit different from the decoding target unit when the parameter information does not match the parameter candidate list. In this way, the image decoder 104 may continue decoding the encoded stream.

Each of the structural elements in each of the above-described embodiments may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or a semiconductor memory. Here, the software program for realizing the image decoding apparatus according to each of the embodiments is a program described below.

For example, the program causes a computer to execute an image decoding method of decoding an encoded stream of images each divided into a plurality of units, the image decoding method including: generating a parameter candidate list including one or more parameter candidates each of which is available to decode a decoding target unit, using one or more parameters used in decoding of one or more decoded units; decoding parameter information included in the encoded stream and related to the one or more parameter candidates; and detecting, as an error, a state in which the parameter information decoded by the parameter information decoder does not have a match in the parameter candidate list generated by the parameter candidate generating unit.

Alternatively, the respective elements may be implemented as circuits. These circuits may be configured as a single circuit as a whole, or may be configured as separate individual circuits. In addition, each of the elements may be implemented as a general-purpose processor, or as a dedicated processor.

Although one or more image decoding devices according to one or more aspects have been described above based on the embodiments, the present invention is not limited to these embodiments. The one or more aspects may cover various modifications made to any of these exemplary embodiments by any person skilled in the art, and other embodiments obtained by combining some of the elements in different ones of the embodiments, without materially departing from the scope of the present invention.

For example, the process which is executed by a particular one of the processing units may be executed by another processing unit. In addition, the order for executing the processes may be changed, or some of the processes may be executed in parallel. In addition, a method similar to the above-described image decoding method may be applied to an image encoding method. In addition, the image encoding device may execute such an image encoding method. In addition, an image encoding and decoding device may include the image encoding device and the image decoding device.

### Embodiment 5

The processing described in each of embodiments can be simply implemented in an independent computer system, by recording, in a recording medium, one or more programs for implementing the configurations of the moving picture encoding method (image encoding method) and the moving picture decoding method (image decoding method) described in each of embodiments. The recording media may be any recording media as long as the program can be recorded, such as a magnetic disk, an optical disk, a magnetic optical disk, an IC card, and a semiconductor memory.

Hereinafter, the applications to the moving picture encoding method (image encoding method) and the moving picture decoding method (image decoding method) described in each of embodiments and systems using thereof will be described. The system has a feature of having an image coding apparatus that includes an image encoding apparatus using the image encoding method and an image decoding apparatus using the image decoding method. Other configurations in the system can be changed as appropriate depending on the cases.

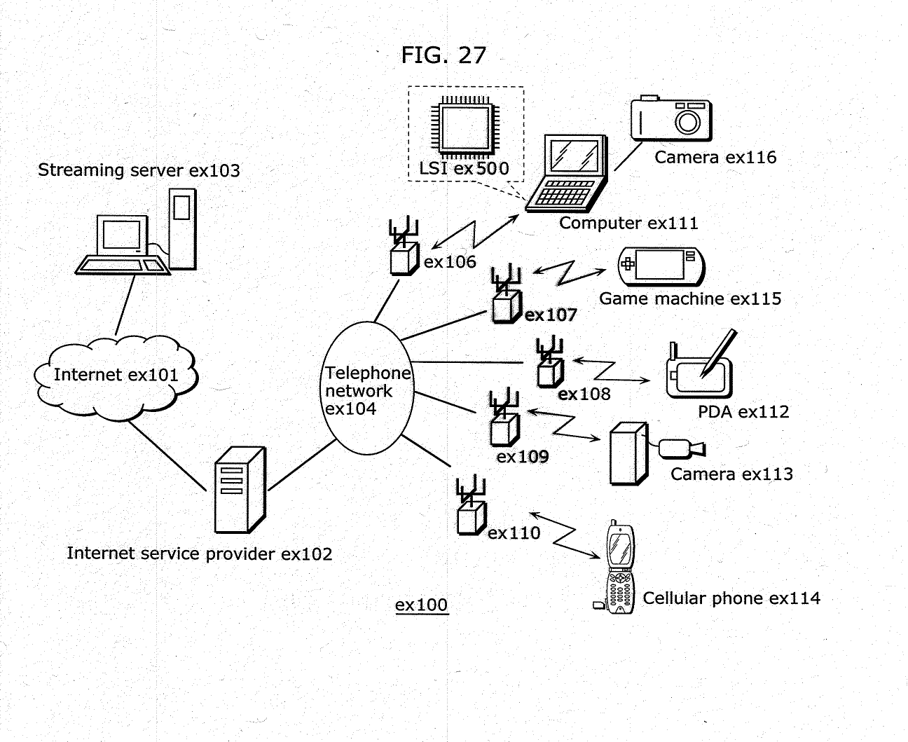

FIG. 27 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 27, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is encoded as described above in each of embodiments (i.e., the camera functions as the image encoding apparatus according to an aspect of the present invention), and the encoded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned encoded data. Each of the devices that have received the distributed data decodes and reproduces the encoded data (i.e., functions as the image decoding apparatus according to an aspect of the present invention).

The captured data may be encoded by the camera ex113 or the streaming server ex103 that transmits the data, or the encoding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The encoding processes may be performed by the camera ex116, the computer ex111, or the streaming server ex103, or shared among them.

Furthermore, the coding processes may be performed by an LSI ex500 generally included in each of the computer ex111 and the devices. The LSI ex500 may be configured of a single chip or a plurality of chips. Software for coding video may be integrated into some type of a recording medium (such as a CD-ROM, a flexible disk, and a hard disk) that is readable by the computer ex111 and others, and the coding processes may be performed using the software. Furthermore, when the cellular phone ex114 is equipped with a camera, the video data obtained by the camera may be transmitted. The video data is data encoded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the encoded data in the content providing system ex100. In other words, the clients can receive and decode information transmitted by the user, and reproduce the decoded data in real time in the content providing system ex100, so that the user who does not have any particular right and equipment can implement personal broadcasting.

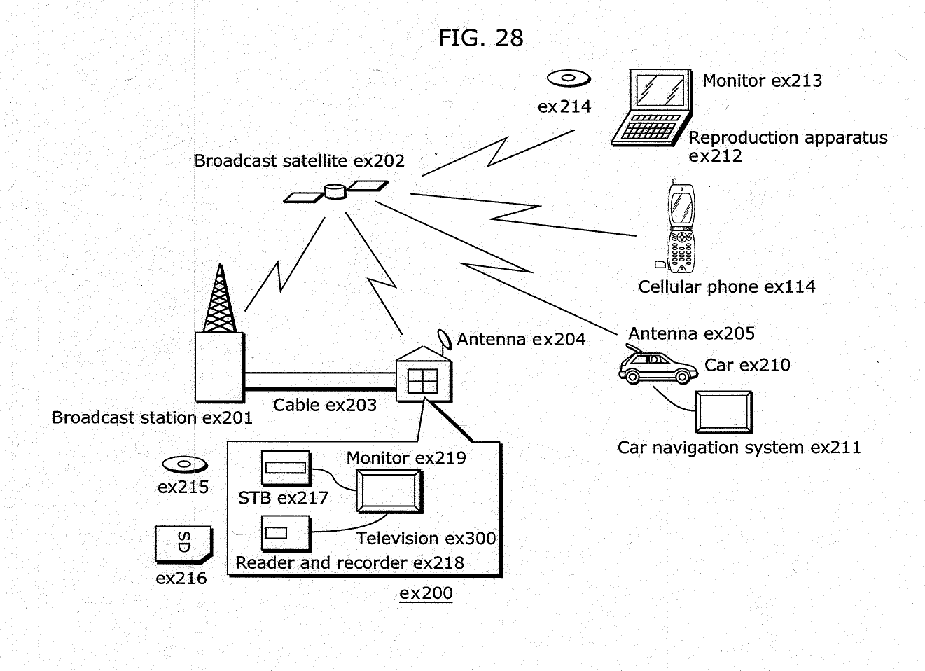

Aside from the example of the content providing system ex100, at least one of the moving picture coding apparatus (image coding apparatus) described in each of embodiments may be implemented in a digital broadcasting system ex200 illustrated in FIG. 28. More specifically, a broadcast station ex201 communicates or transmits, via radio waves to a broadcast satellite ex202, multiplexed data obtained by multiplexing audio data and others onto video data. The video data is data encoded by the moving picture encoding method described in each of embodiments (i.e., data encoded by the image encoding apparatus according to an aspect of the present invention). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (i.e., functions as the image decoding apparatus according to an aspect of the present invention).

Furthermore, a reader/recorder ex218 (i) reads and decodes the multiplexed data recorded on a recording medium ex215, such as a DVD and a BD, or (i) encodes video signals in the recording medium ex215, and in some cases, writes data obtained by multiplexing an audio signal on the encoded data. The reader/recorder ex218 can include the moving picture decoding apparatus or the moving picture encoding apparatus as shown in each of embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

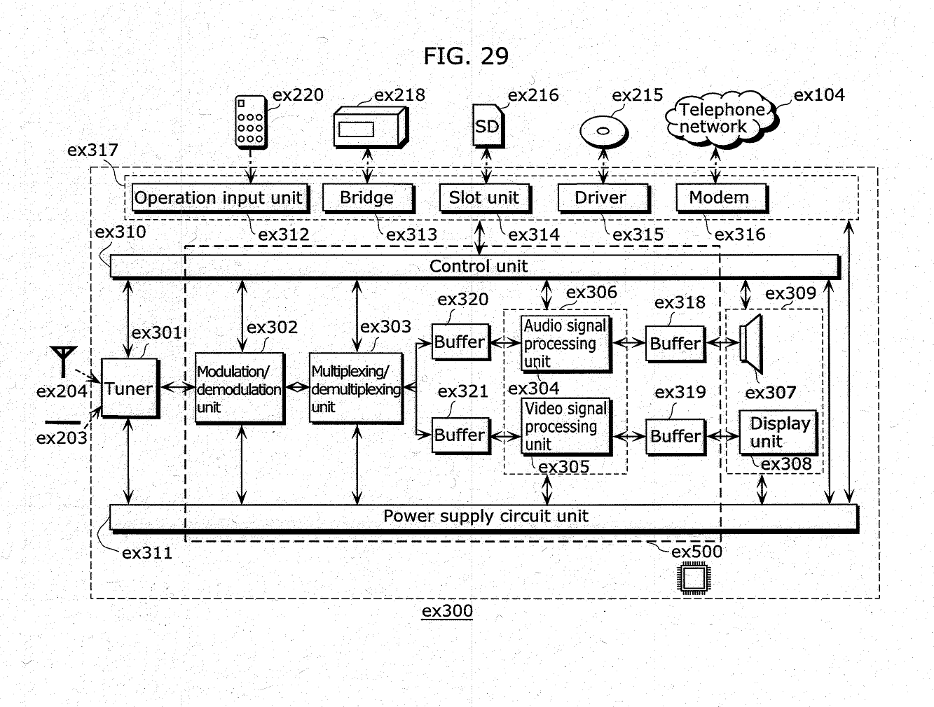

FIG. 29 illustrates the television (receiver) ex300 that uses the moving picture encoding method and the moving picture decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data encoded by a signal processing unit ex306 into data.

The television ex300 further includes: a signal processing unit ex306 including an audio signal processing unit ex304 and a video signal processing unit ex305 that code each of audio data and video data, (which function as the image coding apparatus according to the aspects of the present invention); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 encodes an audio signal and a video signal, and transmits the data outside or writes the data on a recording medium will be described. In the television ex300, upon a user operation through the remote controller ex220 and others, the audio signal processing unit ex304 encodes an audio signal, and the video signal processing unit ex305 encodes a video signal, under control of the control unit ex310 using the encoding method described in each of embodiments. The multiplexing/demultiplexing unit ex303 multiplexes the encoded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may encode the obtained data. Although the television ex300 can encode, multiplex, and provide outside data in the description, it may be capable of only receiving, decoding, and providing outside data but not the encoding, multiplexing, and providing outside data.

Furthermore, when the reader/recorder ex218 reads or writes multiplexed data from or on a recording medium, one of the television ex300 and the reader/recorder ex218 may code the multiplexed data, and the television ex300 and the reader/recorder ex218 may share the coding partly.

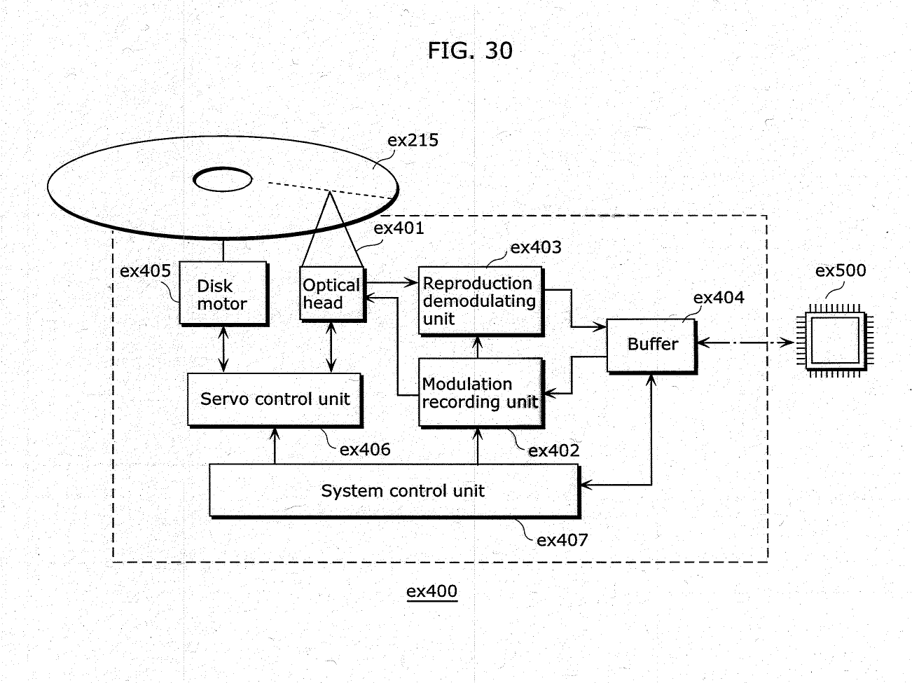

As an example, FIG. 30 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

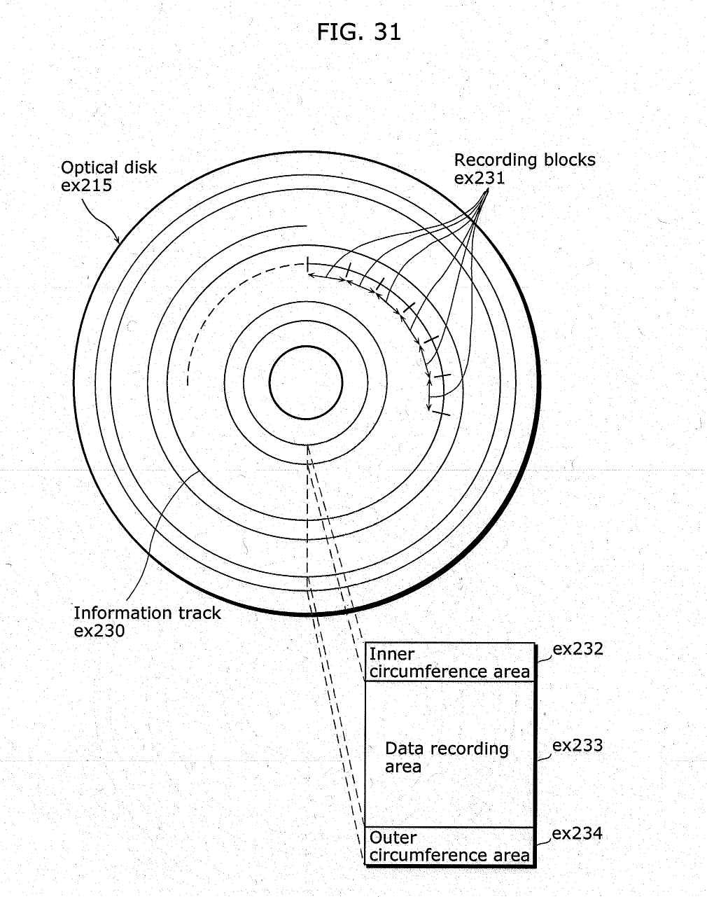

FIG. 31 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes encoded audio, encoded video data, or multiplexed data obtained by multiplexing the encoded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 29. The same will be true for the configuration of the computer ex111, the cellular phone ex114, and others.

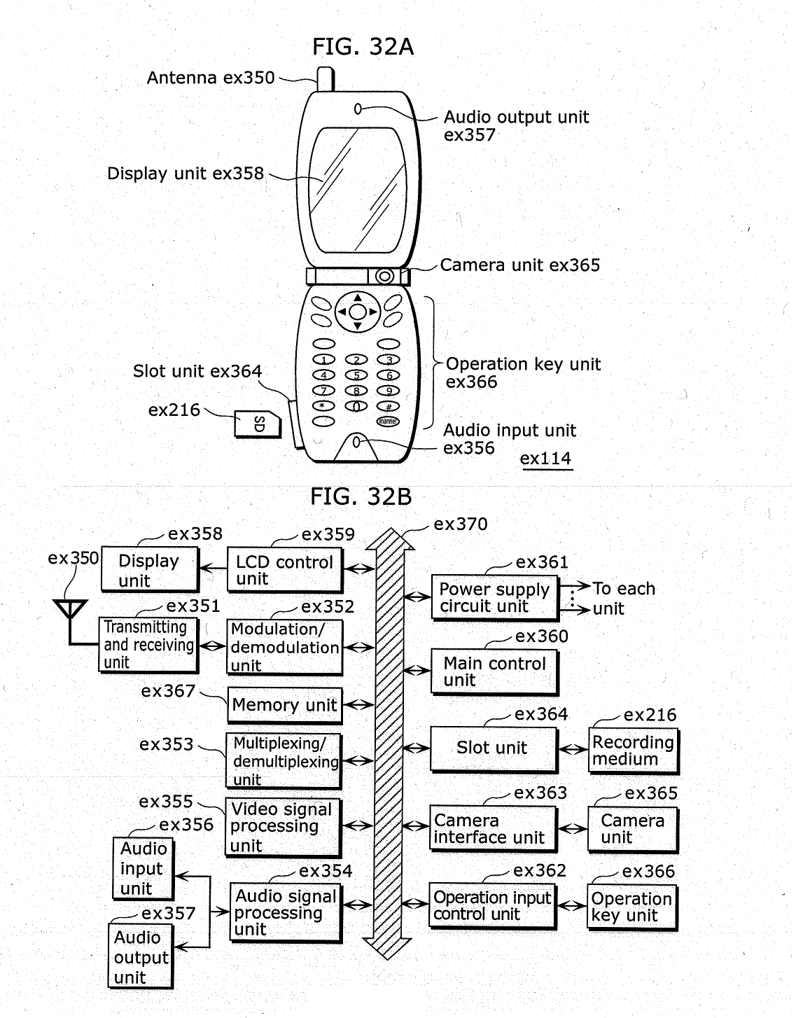

FIG. 32A illustrates the cellular phone ex114 that uses the moving picture coding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 32B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and encodes video signals supplied from the camera unit ex365 using the moving picture encoding method shown in each of embodiments (i.e., functions as the image encoding apparatus according to the aspect of the present invention), and transmits the encoded video data to the multiplexing/demultiplexing unit ex353. In contrast, during when the camera unit ex365 captures video, still images, and others, the audio signal processing unit ex354 encodes audio signals collected by the audio input unit ex356, and transmits the encoded audio data to the multiplexing/demultiplexing unit ex353.

The multiplexing/demultiplexing unit ex353 multiplexes the encoded video data supplied from the video signal processing unit ex355 and the encoded audio data supplied from the audio signal processing unit ex354, using a predetermined method. Then, the modulation/demodulation unit (modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the encoded video data and the audio signal processing unit ex354 with the encoded audio data, through the synchronous bus ex370. The video signal processing unit ex355 decodes the video signal using a moving picture decoding method corresponding to the moving picture encoding method shown in each of embodiments (i.e., functions as the image decoding apparatus according to the aspect of the present invention), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both an encoding apparatus and a decoding apparatus, but also (ii) a transmitting terminal including only an encoding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method in each of embodiments can be used in any of the devices and systems described. Thus, the advantages described in each of embodiments can be obtained.

Furthermore, the present invention is not limited to embodiments, and various modifications and revisions are possible without departing from the scope of the present invention.

### Embodiment 6

Video data can be generated by switching, as necessary, between (i) the moving picture encoding method or the moving picture encoding apparatus shown in each of embodiments and (ii) a moving picture encoding method or a moving picture encoding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture encoding method and by the moving picture encoding apparatus shown in each of embodiments will be hereinafter described. The multiplexed data is a digital stream in the MPEG-2 Transport Stream format.

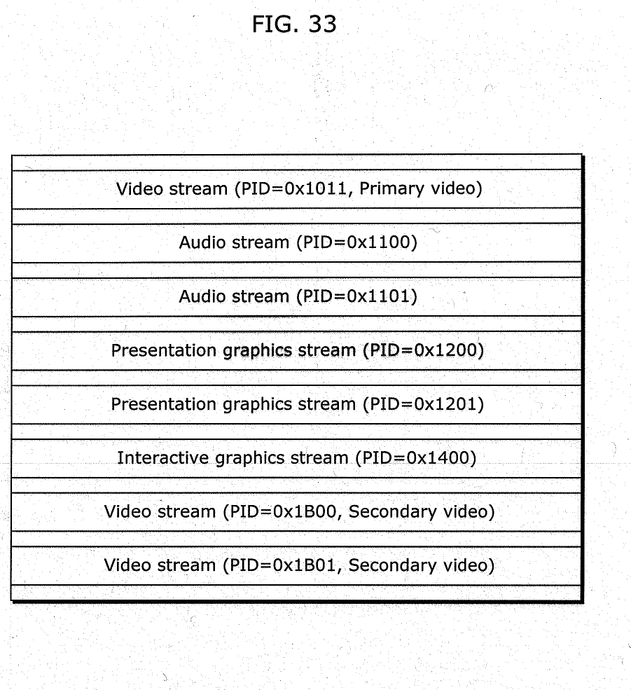

FIG. 33 illustrates a structure of the multiplexed data. As illustrated in FIG. 33, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is encoded in the moving picture encoding method or by the moving picture encoding apparatus shown in each of embodiments, or in a moving picture encoding method or by a moving picture encoding apparatus in conformity with a conventional standard, such as MPEG-2, MPEG-4 AVC, and VC-1. The audio stream is encoded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary audio to be mixed with the primary audio.

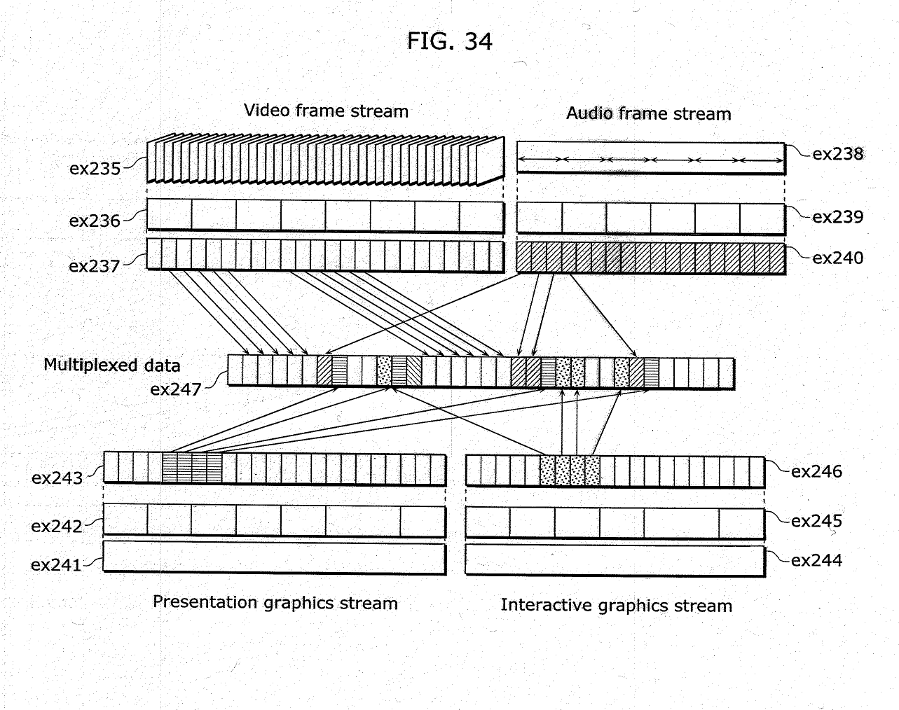

FIG. 34 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

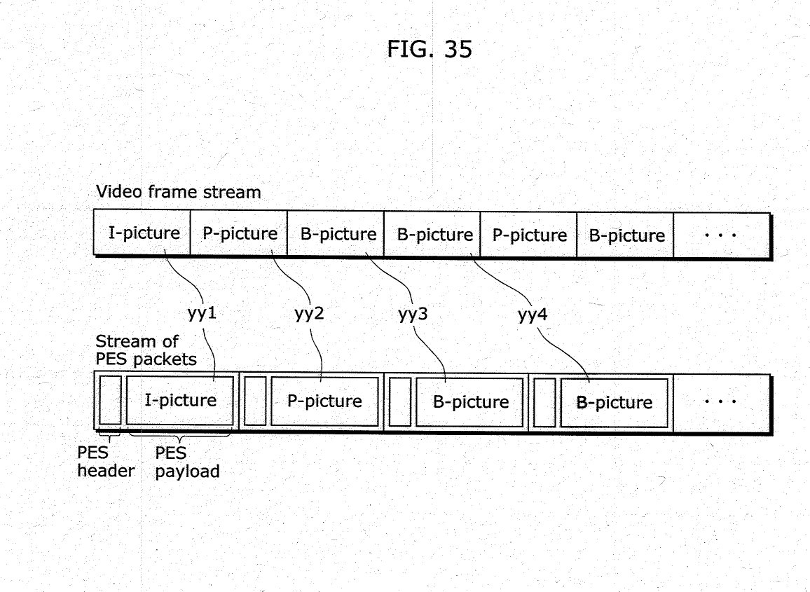

FIG. 35 illustrates how a video stream is stored in a stream of PES packets in more detail. The first bar in FIG. 35 shows a video frame stream in a video stream. The second bar shows the stream of PES packets. As indicated by arrows denoted as yy1, yy2, yy3, and yy4 in FIG. 35, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

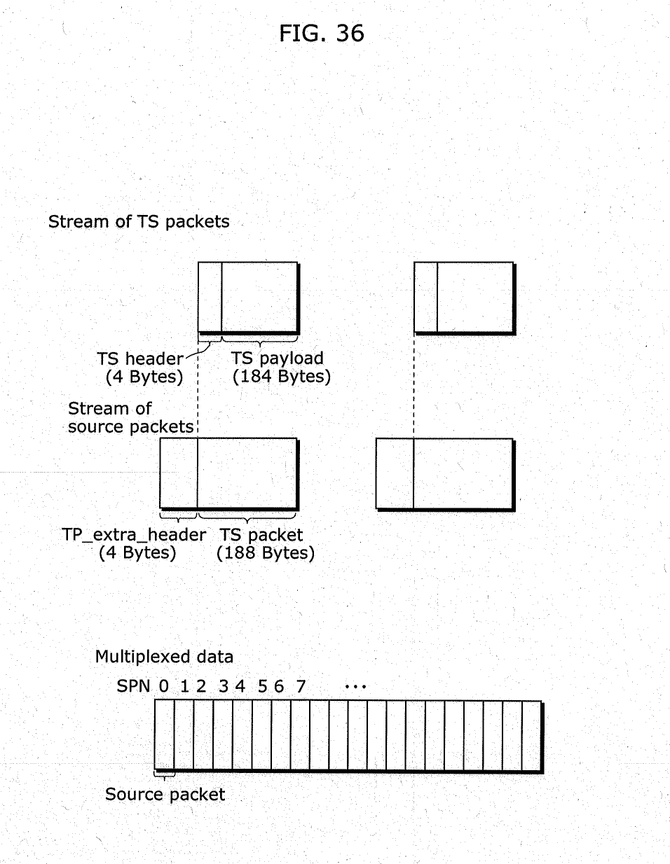

FIG. 36 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 36. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

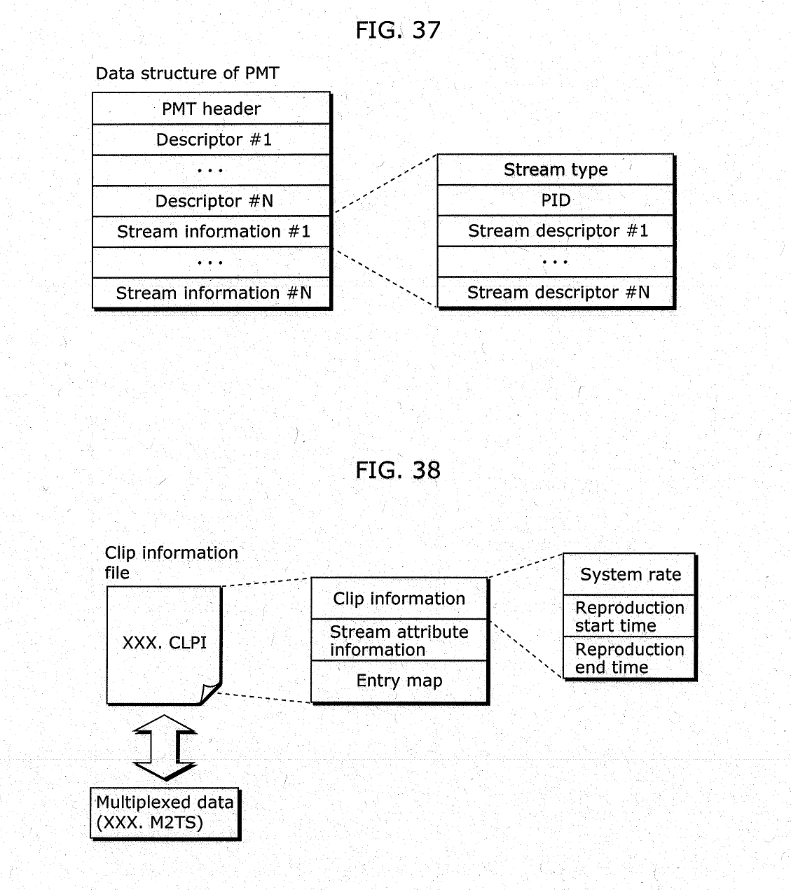

FIG. 37 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

Each of the multiplexed data information files is management information of the multiplexed data as shown in FIG. 38. The multiplexed data information files are in one to one correspondence with the multiplexed data, and each of the files includes multiplexed data information, stream attribute information, and an entry map.

As illustrated in FIG. 38, the multiplexed data information includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

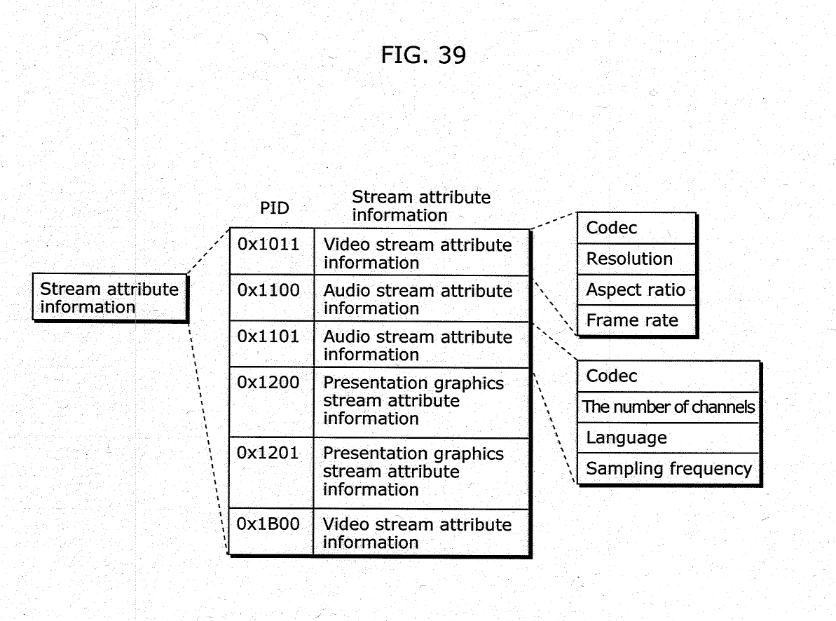

As shown in FIG. 39, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In the present embodiment, the multiplexed data to be used is of a stream type included in the PMT. Furthermore, when the multiplexed data is recorded on a recording medium, the video stream attribute information included in the multiplexed data information is used. More specifically, the moving picture encoding method or the moving picture encoding apparatus described in each of embodiments includes a step or a unit for allocating unique information indicating video data generated by the moving picture encoding method or the moving picture encoding apparatus in each of embodiments, to the stream type included in the PMT or the video stream attribute information. With the configuration, the video data generated by the moving picture encoding method or the moving picture encoding apparatus described in each of embodiments can be distinguished from video data that conforms to another standard.

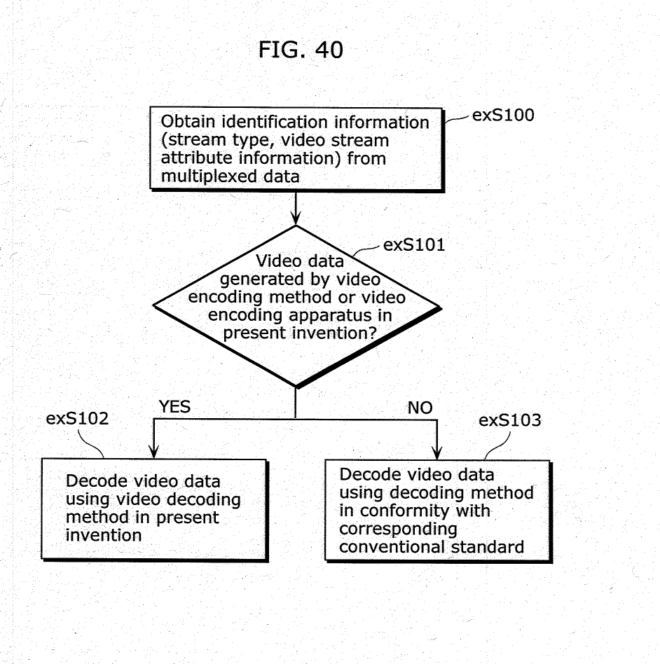

Furthermore, FIG. 40 illustrates steps of the moving picture decoding method according to the present embodiment. In Step exS100, the stream type included in the PMT or the video stream attribute information included in the multiplexed data information is obtained from the multiplexed data. Next, in Step exS101, it is determined whether or not the stream type or the video stream attribute information indicates that the multiplexed data is generated by the moving picture encoding method or the moving picture encoding apparatus in each of embodiments. When it is determined that the stream type or the video stream attribute information indicates that the multiplexed data is generated by the moving picture encoding method or the moving picture encoding apparatus in each of embodiments, in Step exS102, decoding is performed by the moving picture decoding method in each of embodiments. Furthermore, when the stream type or the video stream attribute information indicates conformance to the conventional standards, such as MPEG-2, MPEG-4 AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of embodiments can perform decoding. Even when multiplexed data that conforms to a different standard is input, an appropriate decoding method or apparatus can be selected. Thus, it becomes possible to decode information without any error. Furthermore, the moving picture encoding method or apparatus, or the moving picture decoding method or apparatus in the present embodiment can be used in the devices and systems described above.

### Embodiment 7

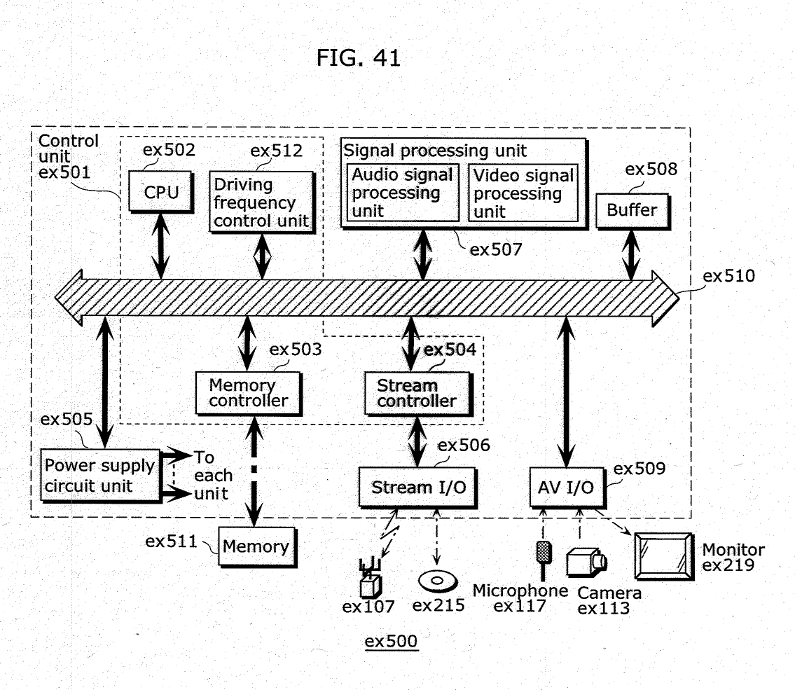

Each of the moving picture coding method and the moving picture coding apparatus in each of embodiments is typically achieved in the form of an integrated circuit or a Large Scale Integrated (LSI) circuit. As an example of the LSI, FIG. 41 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when encoding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 encodes an audio signal and/or a video signal. Here, the encoding of the video signal is the encoding described in each of embodiments. Furthermore, the signal processing unit ex507 sometimes multiplexes the encoded audio data and the encoded video data, and a stream IO ex506 provides the multiplexed data outside. The provided multiplexed data is transmitted to the base station ex107, or written on the recording medium ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose. Such a programmable logic device can typically execute the moving picture coding method according to any of the above embodiments, by loading or, reading from a memory or the like one or more programs that are included in software or firmware.

In the future, with advancement in semiconductor technology, a brand-new technology may replace LSI. The functional blocks can be integrated using such a technology. The possibility is that the present invention is applied to biotechnology.

### Embodiment 8

When video data generated in the moving picture encoding method or by the moving picture encoding apparatus described in each of embodiments is decoded, compared to when video data that conforms to a conventional standard, such as MPEG-2, MPEG-4 AVC, and VC-1 is decoded, the processing amount probably increases. Thus, the LSI ex500 needs to be set to a driving frequency higher than that of the CPU ex502 to be used when video data in conformity with the conventional standard is decoded. there is a problem that the power consumption increases.

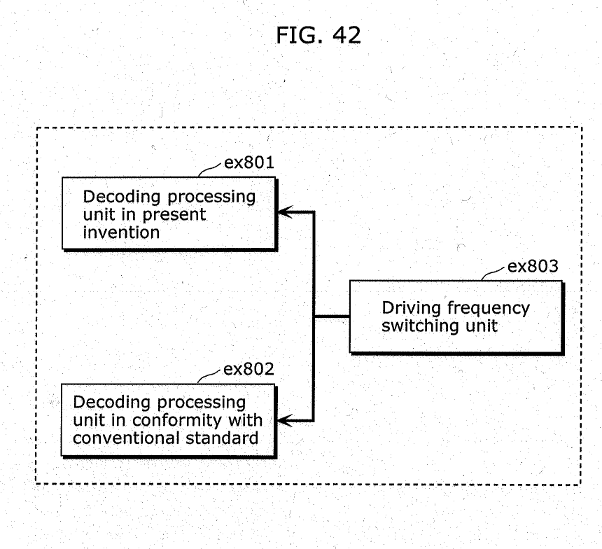

In order to solve the problem, the moving picture decoding apparatus, such as the television ex300 and the LSI ex500 is configured to determine to which standard the video data conforms, and switch between the driving frequencies according to the determined standard. FIG. 42 illustrates a configuration ex800 in the present embodiment. A driving frequency switching unit ex803 sets a driving frequency to a higher driving frequency when video data is generated by the moving picture encoding method or the moving picture encoding apparatus described in each of embodiments. Then, the driving frequency switching unit ex803 instructs a decoding processing unit ex801 that executes the moving picture decoding method described in each of embodiments to decode the video data. When the video data conforms to the conventional standard, the driving frequency switching unit ex803 sets a driving frequency to a lower driving frequency than that of the video data generated by the moving picture encoding method or the moving picture encoding apparatus described in each of embodiments. Then, the driving frequency switching unit ex803 instructs the decoding processing unit ex802 that conforms to the conventional standard to decode the video data.

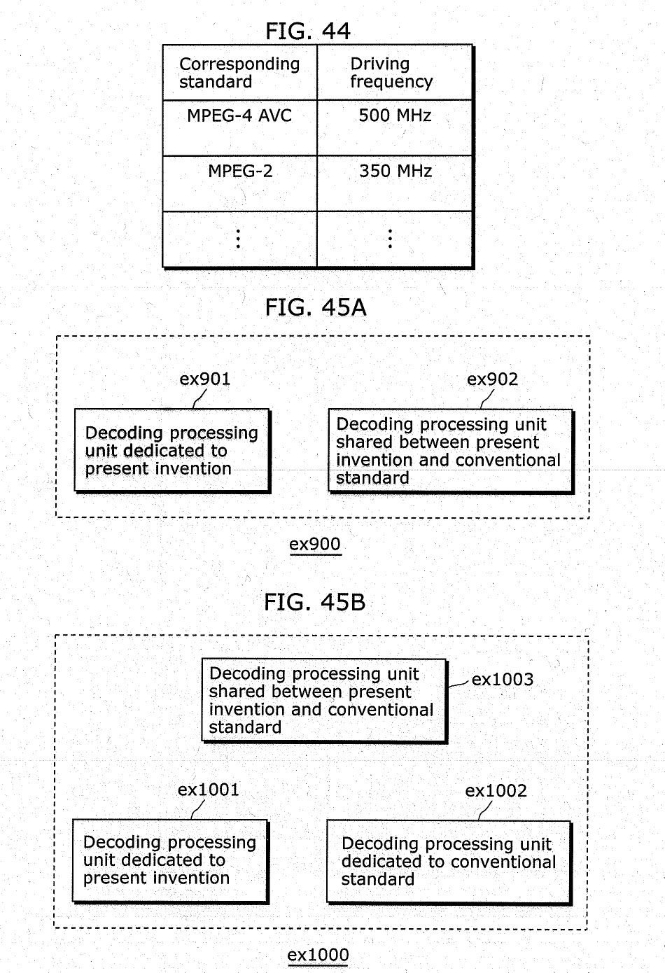

More specifically, the driving frequency switching unit ex803 includes the CPU ex502 and the driving frequency control unit ex512 in FIG. 41. Here, each of the decoding processing unit ex801 that executes the moving picture decoding method described in each of embodiments and the decoding processing unit ex802 that conforms to the conventional standard corresponds to the signal processing unit ex507 in FIG. 41. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 6 is probably used for identifying the video data. The identification information is not limited to the one described in Embodiment 6 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 44. The driving frequency can be selected by storing the look-up table in the buffer ex508 and in an internal memory of an LSI, and with reference to the look-up table by the CPU ex502.

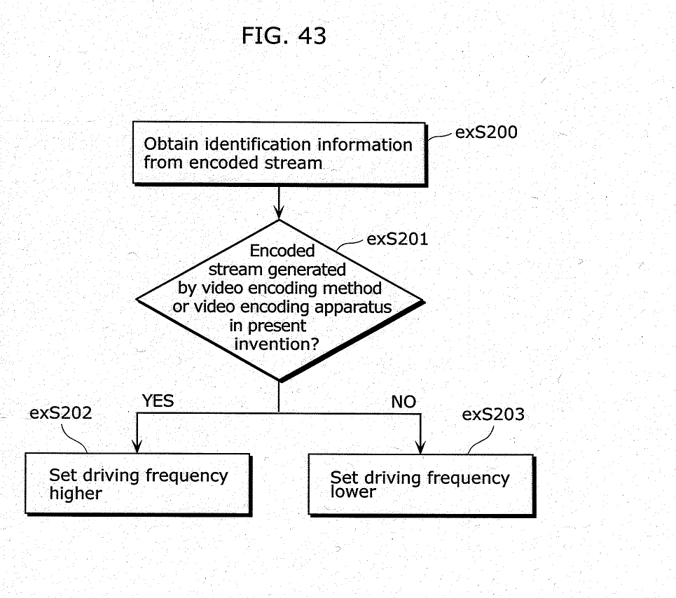

FIG. 43 illustrates steps for executing a method in the present embodiment. First, in Step exS200, the signal processing unit ex507 obtains identification information from the multiplexed data. Next, in Step exS201, the CPU ex502 determines whether or not the video data is generated by the encoding method and the encoding apparatus described in each of embodiments, based on the identification information. When the video data is generated by the moving picture encoding method and the moving picture encoding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture encoding method and the moving picture encoding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG-4 AVC is larger than the processing amount for decoding video data generated by the moving picture encoding method and the moving picture encoding apparatus described in each of embodiments, the driving frequency is probably set in reverse order to the setting described above.

Furthermore, the method for setting the driving frequency is not limited to the method for setting the driving frequency lower. For example, when the identification information indicates that the video data is generated by the moving picture encoding method and the moving picture encoding apparatus described in each of embodiments, the voltage to be applied to the LSI ex500 or the apparatus including the LSI ex500 is probably set higher. When the identification information indicates that the video data conforms to the conventional standard, such as MPEG-2, MPEG-4 AVC, and VC-1, the voltage to be applied to the LSI ex500 or the apparatus including the LSI ex500 is probably set lower. As another example, when the identification information indicates that the video data is generated by the moving picture encoding method and the moving picture encoding apparatus described in each of embodiments, the driving of the CPU ex502 does not probably have to be suspended. When the identification information indicates that the video data conforms to the conventional standard, such as MPEG-2, MPEG-4 AVC, and VC-1, the driving of the CPU ex502 is probably suspended at a given time because the CPU ex502 has extra processing capacity. Even when the identification information indicates that the video data is generated by the moving picture encoding method and the moving picture encoding apparatus described in each of embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### Embodiment 9

There are cases where a plurality of video data that conforms to different standards, is provided to the devices and systems, such as a television and a cellular phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

In order to solve the problem, what is conceived is a configuration in which the decoding processing unit for implementing the moving picture decoding method described in each of embodiments and the decoding processing unit that conforms to the conventional standard, such as MPEG-2, MPEG-4 AVC, and VC-1 are partly shared. Ex900 in FIG. 45A shows an example of the configuration. For example, the moving picture decoding method described in each of embodiments and the moving picture decoding method that conforms to MPEG-4 AVC have, partly in common, the details of processing, such as entropy encoding, inverse quantization, deblocking filtering, and motion compensated prediction. The details of processing to be shared probably include use of a decoding processing unit ex902 that conforms to MPEG-4 AVC. In contrast, a dedicated decoding processing unit ex901 is probably used for other processing which is unique to an aspect of the present invention and does not conform to MPEG-4 AVC. Since the aspect of the present invention is characterized by motion compensation in particular, for example, the dedicated decoding processing unit ex901 is used for motion compensation. Otherwise, the decoding processing unit is probably shared for one of the entropy decoding, deblocking filtering, and inverse quantization, or all of the processing. The decoding processing unit for implementing the moving picture decoding method described in each of embodiments may be shared for the processing to be shared, and a dedicated decoding processing unit may be used for processing unique to that of MPEG-4 AVC.

Furthermore, ex1000 in FIG. 45B shows another example in that processing is partly shared. This example uses a configuration including a dedicated decoding processing unit ex1001 that supports the processing unique to an aspect of the present invention, a dedicated decoding processing unit ex1002 that supports the processing unique to another conventional standard, and a decoding processing unit ex1003 that supports processing to be shared between the moving picture decoding method according to the aspect of the present invention and the conventional moving picture decoding method. Here, the dedicated decoding processing units ex1001 and ex1002 are not necessarily specialized for the processing according to the aspect of the present invention and the processing of the conventional standard, respectively, and may be the ones capable of implementing general processing. Furthermore, the configuration of the present embodiment can be implemented by the LSI ex500.

As such, reducing the scale of the circuit of an LSI and reducing the cost are possible by sharing the decoding processing unit for the processing to be shared between the moving picture decoding method according to the aspect of the present invention and the moving picture decoding method in conformity with the conventional standard.

### INDUSTRIAL APPLICABILITY

The present invention can be used to various applications. For example, the present invention is applicable to high-resolution information display devices and imaging devices such as television receivers, digital video recorders, car navigation systems, mobile phones, digital cameras, and digital video cameras, and is thus highly applicable.

### REFERENCE SIGNS LIST

100, 200, 300, 500 Image decoding device
101 Parameter candidate generating unit
102 Parameter information decoder
103 Error detecting unit
104 Image decoder
501 Control unit
502 Frame memory
503 Variable length decoder
504 Inverse quantizing unit
505 Inverse frequency transforming unit
506 Motion compensating unit
507 Intra predicting unit
508 Reconstructing unit
509 Reconstructed image memory
510 In-loop filter unit
511 Motion vector calculating unit
512 DMA control unit
513 Reference image storing unit
514 Prediction image storing unit
515 Motion vector storing unit
516 Motion compensation processing unit

1-18. (canceled)

19. An image decoding device which decodes an encoded stream of images each divided into a plurality of units, the image decoding device comprising:
a parameter candidate generating unit configured to generate, for each of decoding target units, a parameter candidate list including one or more parameter candidates each of which is available to decode the decoding target unit, using one or more parameters used in decoding of one or more decoded units;
a parameter information decoder which decodes parameter information included in the encoded stream and related to the one or more parameter candidates; and
an error detecting unit configured to detect, as an error, a state in which the parameter information decoded by the parameter information decoder does not have a match in the parameter candidate list generated by the parameter candidate generating unit.

20. The image decoding device according to claim 19,
wherein the parameter information decoder decodes the parameter information which is information for identifying a parameter to be used to decode the decoding target unit from the parameter candidate list, and
the error detecting unit is configured to detect, as the error, the state which is a state in which the parameter identified by the parameter information decoded by the parameter information decoder is absent in the parameter candidate list.

21. The image decoding device according to claim 19,
wherein the parameter information decoder decodes the parameter information which indicates a largest number for the one or more parameter candidates, and
the error detecting unit is configured to detect, as the error, the state which is a state in which the number of the one or more parameter candidates included in the parameter candidate list generated by the parameter candidate generating unit is larger than the largest number indicated by the parameter information decoded by the parameter information decoder.

22. The image decoding device according to claim 19,
wherein the parameter information decoder decodes the parameter information which is information indicating an identification number of a parameter to be used to decode the decoding target unit from the parameter candidate list, and
the error detecting unit is configured to detect, as the error, the state which is a state in which the identification number indicated by the parameter information decoded by the parameter information decoder is larger than the largest number for the one or more parameter candidates included in the parameter candidate list.

23. The image decoding device according to claim 19,
wherein each of the plurality of units is a prediction unit.

24. The image decoding device according to claim 23,
wherein each of the one or more parameter candidates included in the parameter candidate list is a motion vector predictor candidate.

25. The image decoding device according to claim 23,
wherein each of the one or more parameter candidates included in the parameter candidate list is an intra prediction mode candidate.

26. The image decoding device according to claim 19, further comprising
an image decoder which identifies a parameter to be used to decode the decoding target unit from the parameter candidate list, based on the parameter information decoded by the parameter information decoder, and decodes the decoding target unit using the parameter,
wherein the image decoder continues decoding the encoded stream even when the error is detected by the error detecting unit.

27. The image decoding device according to claim 26,
wherein when the error is detected by the error detecting unit, the image decoder continues decoding the encoded stream by concealing the error.

28. The image decoding device according to claim 27,
wherein when the error is detected by the error detecting unit, the image decoder conceals the error by identifying an alternative parameter from the parameter candidate list, and decoding the decoding target unit using the alternative parameter.

29. The image decoding device according to claim 27,
wherein when the error is detected by the error detecting unit, the image decoder conceals the error by decoding the decoding target unit using a predetermined alternative parameter.

30. The image decoding device according to claim 26,
wherein when the error is detected by the error detecting unit, the image decoder continues decoding the encoded stream by decoding a unit different from the decoding target unit.

31. An image decoding device which decodes an encoded stream of images each divided into a plurality of units, the image decoding device comprising:
a parameter candidate generating unit configured to generate, for each of decoding target units, a parameter candidate list including one or more parameter candidates each of which is available to decode the decoding target unit, using one or more parameters used in decoding of one or more decoded units;
a parameter information decoder which decodes parameter information included in the encoded stream and related to the one or more parameter candidates; and
an image decoder which identifies a parameter to be used to decode the decoding target unit from the parameter candidate list, based on the parameter information decoded by the parameter information decoder, and decodes the decoding target unit using the parameter,
wherein the image decoder continues decoding the encoded stream even when the parameter information decoded by the parameter information decoder does not have a match in the parameter candidate list generated by the parameter candidate generating unit.

32. The image decoding device according to claim 31,
wherein when the parameter information does not have a match in the parameter candidate list, the image decoder continues decoding the encoded stream by decoding the decoding target unit using an alternative parameter.

33. The image decoding device according to claim 31,
wherein when the parameter information does not have a match in the parameter candidate list, the image decoder continues decoding the encoded stream by decoding a unit different from the decoding target unit.

34. An image decoding method of decoding an encoded stream of images each divided into a plurality of units, the image decoding method comprising:
generating, for each of decoding target units, a parameter candidate list including one or more parameter candidates each of which is available to decode the decoding target unit, using one or more parameters used in decoding of one or more decoded units;
decoding parameter information included in the encoded stream and related to the one or more parameter candidates; and
detecting, as an error, a state in which the parameter information decoded by the parameter information decoder does not have a match in the parameter candidate list generated by the parameter candidate generating unit.

35. A non-transitory computer-readable recording medium having a program recorded thereon for causing a computer to execute the image decoding method according to claim 34.

36. An integrated circuit which decodes an encoded stream of images each divided into a plurality of units, the integrated circuit comprising:
a parameter candidate generating unit configured to generate, for each of decoding target units, a parameter candidate list including one or more parameter candidates each of which is available to decode the decoding target unit, using one or more parameters used in decoding of one or more decoded units;
a parameter information decoder which decodes parameter information included in the encoded stream and related to the one or more parameter candidates; and
an error detecting unit configured to detect, as an error, a state in which the parameter information decoded by the parameter information decoder does not have a match in the parameter candidate list generated by the parameter candidate generating unit.

37. An image decoding device according to claim 19,
wherein the parameter candidate generating unit is configured to generate the parameter candidate list, using, as the one or more parameters, a motion vector in a decoded unit spatially neighboring the decoding target unit and a motion vector in a decoded unit included in a picture temporally neighboring a picture including the decoding target unit.
